(19) United States
(12) Patent Application Publication
(10) Pub. No.: US 2019/0023986 A1
(43) Pub. Date: Jan. 24, 2019

(54) OPTICAL FILM, POLARIZING PLATE, AND IMAGE DISPLAY DEVICE

(71) Applicant: FUJIFILM Corporation, Tokyo (JP)

(72) Inventors: Shinichi YOSHINARI, Kanagawa (JP); Hiroshi SATO, Kanagawa (JP); Shinnosuke SAKAI, Kanagawa (JP); Keita TAKAHASHI, Kanagawa (JP); Naozumi SHIRAIWA, Kanagawa (JP); Hiroshi MATSUYAMA, Kanagawa (JP)

(73) Assignee: FUJIFILM Corporation, Tokyo (JP)

(21) Appl. No.: 16/142,538

(22) Filed: Sep. 26, 2018

Related U.S. Application Data
(63) Continuation of application No. PCT/JP2017/012467, filed on Mar. 27, 2017.

(30) Foreign Application Priority Data
Mar. 30, 2016 (JP) 2016-068948

(51) Int. Cl. C09K 19/34; G02B 5/30; C09K 19/54

(52) U.S. Cl. CPC C09K 19/3491; G02F 1/133528; C09K 19/54; G02B 5/3016

(57) ABSTRACT

An object of the present invention is to provide an optical film having an optically anisotropic layer having excellent durability, and a polarizing plate and an image display device using the same. This optical film of the present invention is an optical film at least having an optically anisotropic layer, in which the optically anisotropic layer is a layer obtained by polymerizing a polymerizable liquid crystal composition containing a predetermined liquid crystal compound, a predetermined mesogen compound, and a polymerization initiator, an I/O value of the liquid crystal compound is more than 0.56, and an I/O value of the mesogen compound is 0.56 or less.

### CROSS-REFERENCE TO RELATED APPLICATIONS

This application is a Continuation of PCT International Application No. PCT/JP2017/012467 filed on Mar. 27, 2017, which claims priority under 35 U.S.C. § 119(a) to Japanese Patent Application No. 2016-068948 filed on Mar. 30, 2016. The above application is hereby expressly incorporated by reference, in its entirety, into the present application.

### BACKGROUND OF THE INVENTION

### 1. Field of the Invention

The present invention relates to an optical film, a polarizing plate, and an image display device.

### 2. Description of the Related Art

Optical films such as an optical compensation sheet and a phase difference film are used for various image display devices to eliminate image coloration and to broaden the viewing angle.

Stretched birefringent films have been employed as optical films. However, in recent years, instead of stretched birefringent films, the use of optical films having optically anisotropic layers formed of liquid crystal compounds has been proposed,

As such an optical film, for example, JP2010-031223A discloses an optical film obtained by polymerizing a compound which contains a predetermined group and a polymerizable group ([claim 12]).

In addition, JP2015-200861A discloses an optically anisotropic layer formed using a polymerizable composition including one or more polymerizable rod-like liquid crystal compounds exhibiting a smectic phase ([claim 1]).

### SUMMARY OF THE INVENTION

The present inventors have conducted investigations on the optical film disclosed in JP2010-031223A and the optically anisotropic layer disclosed in JP2015-200861A, and have found that, in a case where an optically anisotropic layer to be formed is exposed to a high temperature and high humidity environment, there is a problem in durability that the birefringence index of the optically anisotropic layer changes depending on polymerization conditions such as the kind of a polymerizable liquid crystal compound and a polymerization initiator to be used and the curing temperature thereof.

Here, an object of the present invention is to provide an optical film having an optically anisotropic layer having excellent durability, and a polarizing plate and an image display device using the same.

As a result of intensive investigations to achieve the above object, the present inventors have found that in a case of using a liquid crystal compound having a predetermined structure and having a specific I/O value, and a mesogen compound having a specific I/O value, the durability of an optically anisotropic layer to be formed becomes satisfactory, and thus have completed the present invention.

That is, it has been found that the above object can be achieved by adopting the following configurations.

[1] An optical film comprising at least: an optically anisotropic layer, in which the optically anisotropic layer is a layer obtained by polymerizing a polymerizable liquid crystal composition containing a liquid crystal compound represented by Formula (1) described later, and a mesogen compound having two or more polymerizable groups, and a polymerization initiator, an I/O value of the liquid crystal compound is more than 0.56, and an I/O value of the mesogen compound is 0.56 or less.

[2] The optical film according to [1], in which the liquid crystal compound is a liquid crystal compound exhibiting reverse wavelength dispersion.

[3] The optical film according to [1] or [2], in which a content of the mesogen compound is 4% by mass or more with respect to a total mass of the liquid crystal compound and the mesogen compound.

[4] The optical film according to any one of [1] to [3], in which the liquid crystal compound is a liquid crystal compound represented by Formula (1) described later in which m is 1 or 2.

[5] The optical film according to any one of [1] to [4], in which the polymerization initiator is an oxime type polymerization initiator.

[6] The optical film according to any one of [1] to [5], in which the mesogen compound has at least one ring structure selected from the group consisting of a benzene ring and a cyclohexane ring.

[7] The optical film according to any one of [1] to [6], in which the number of cyclohexane rings in the mesogen compound is 2 or less. [8] A polarizing plate comprising: the optical film according to any one of [1] to [7]; and a polarizer.

[9] An image display device comprising: the optical film according to any one of [1] to [7]; or the polarizing plate according to [8].

According to the present invention, it is possible to provide an optical film having an optically anisotropic layer having excellent durability, and a polarizing plate and an image display device using the same.

### BRIEF DESCRIPTION OF THE DRAWINGS

FIG. 1A is a cross-sectional view schematically showing an example of an optical film according to the present invention.

FIG. 1B is a cross-sectional view schematically showing another example of the optical film according to the present invention.

FIG. 1C is a cross-sectional view schematically showing still another example of the optical film according to the present invention.

### DESCRIPTION OF THE PREFERRED EMBODIMENTS

Hereinafter, the present invention will be described in detail.

The description of the constitutional requirements described below is made on the basis of representative embodiments of the present invention, but it should not be construed that the present invention is limited to those embodiments.

In this specification, numerical value ranges expressed by the term “to” mean that the numerical values described before and after “to” are included as a lower limit and an upper limit, respectively.

[Optical Film]

An optical film of the present invention is an optical film having at least an optically anisotropic layer, the optically anisotropic layer is a layer obtained by polymerizing a polymerizable liquid crystal composition containing a liquid crystal compound represented by Formula (1) described later, a mesogen compound having two or more polymerizable groups, and a polymerization initiator, an I/O value of the liquid crystal compound is more than 0.56, and an I/O value of the mesogen compound is 0.56 or less.

As described above, in the present invention, it is found that the liquid crystal compound having a structure represented by Formula (1) described later and an I/O value of more than 0.56, and the mesogen compound having an I/O value of 0.56 or less are used so that the durability of the optically anisotropic layer becomes satisfactory.

Although the details thereof are not clear, the present inventors have assumed as follows.

First, an ester bond included in the structure of the liquid crystal compound is present even after polymerization, that is, after the optically anisotropic layer is formed, but the present inventors assume that a part of the liquid crystal compound fixed by a polymerizable group is separated to have mobility through a hydrolysis reaction of a hydrolyzable bond such as this ester bond in a high temperature and high humidity environment and a birefringence index is changed.

Therefore, in the present invention, it is considered that by using the mesogen compound having an I/O value of 0.56 or less, a network structure that water hardly penetrates is formed even in a high temperature and high humidity environment.

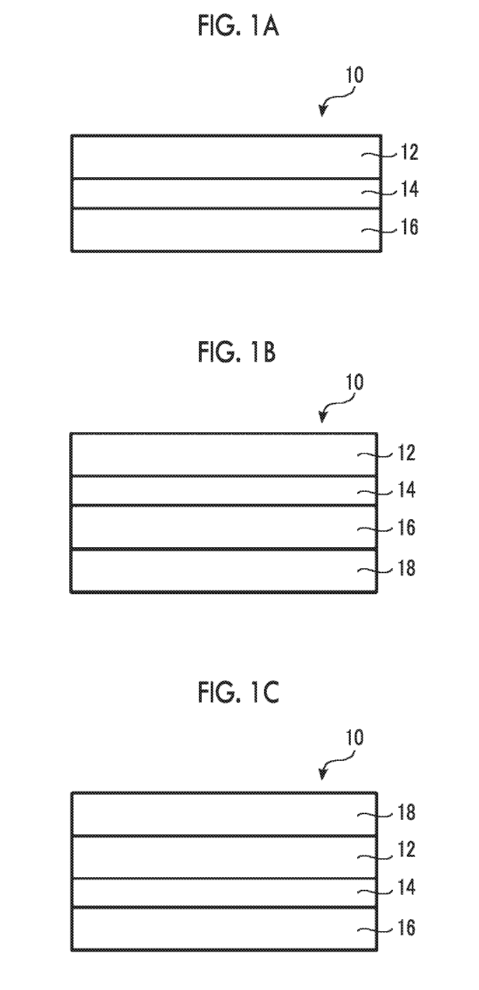

FIGS. 1A to 1C are cross-sectional views schematically showing examples of the optical film according to the present invention, respectively.

FIGS. 1A to 1C are schematic views and the thicknesses relationship and positional. relationship between the respective layers or the like do not necessarily coincide with actual ones. Any of the support, alignment film, and hard coat layer shown in FIGS. 1A to 1C is an arbitrary constitutional member.

An optical film 10 shown in FIGS. 1A to 1C has a support. 16, an alignment film 14, and an optically anisotropic layer 12 in this order.

In addition, the optical film 10 may have a hard coat layer 18 on the side of the support 16 opposite to the side on which the alignment film 14 is provided as shown in FIG. 1B and may have a hard coat layer 18 on the side of the optically anisotropic layer 12 opposite to the side on which the alignment film 14 is provided as shown in FIG. 1C.

Hereinafter, various members used for the optical film of the present invention will be described in detail.

[Optically Anisotropic Layer]

The optically anisotropic layer of the optical film of the present invention is a layer obtained by polymerizing a polymerizable liquid crystal composition containing a liquid crystal compound represented by Formula (1), the mesogen compound having two or more polymerizable groups, and a polymerization initiator.

In addition, the I/O value of the liquid crystal compound is more than 0.56 and the I/O value of the mesogen compound is 0.56 or less.

Herein, the term “I/O value” is used as one measure for predicting various physicochemical properties of an organic compound. The magnitude of organicity is obtained by comparison of the number of carbon atoms and the magnitude of inorganicity is obtained by comparison of the boiling points of the same number of hydrocarbons as the number of carbon atoms. For example, the organicity value of one (—CH₂—) (actually C) is determined as 20 and the inorganicity value thereof is determined as 100 from the viewpoint of influence of a hydroxyl group (−OH) on the boiling point. Based on the inorganicity value of (−OH) of 100, values of other substituents (inorganic groups) arc obtained, which is shown as an “inorganic group table”. According to the inorganic group table, the ratio I/O of inorganicity (I) value and organicity (O) value obtained for each molecule is defined as “I/O value”. The larger the I/O value, the higher the hydrophilicity thereof, and the smaller the I/O value, the stronger the hydrophobicity.

In the present invention, the “I/O value” is a value of “inorganicity (I)/organicity (O)” obtained by a method described in “YOSHIO KOUDA et al, “New edition Organic Conceptual Diagram Foundation and Application”, November 2008, SANKYO PUBLISHING”.

<Liquid Crystal Compound>

The polymerizable liquid crystal composition forming the optically anisotropic layer includes the liquid crystal compound represented by Formula (1) and having an I/O value of more than 0.56.

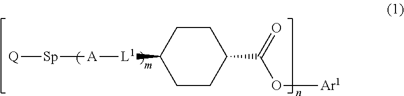

Herein, in Formula (1), A¹ represents an n-valent aromatic group,

L¹ represents a single bond, —COO—, or —OCO—,

A represents an aromatic ring having 6 or more carbon atoms or a cycloalkylene ring having 6 or more carbon atoms,

Sp represents a single bond, a linear or branched alkylene group having 1 to 12 carbon atoms, or a divalent linking group in which one or more —CH₂— groups that constitute a linear or branched alkylene group having 1 to 12 carbon atoms are substituted with —O—, —S—, —NH—, —N(Q)-, or —CO—, and

Q represents a polymerizable group, m represents an integer of 0 to 2, and n represents an integer of 1 or 2.

Herein, all of L¹, A, Sp, and Q, a plurality of which are provided depending on the number of m or n, may be the same or different from each other.

In Formula (1), an aromatic group represented by Ar¹ refers to a group having a ring having aromaticity and for example, an n-valent group having at least one aromatic ring selected from the group consisting of an aromatic hydrocarbon ring and an aromatic heterocyclic ring may be used. Herein, examples of the aromatic hydrocarbon ring include a benzene ring, a naphthalene ring, an anthracene ring, and a phenanthroline ring, and examples of the aromatic heterocyclic ring include a furan ring, a pyrrole ring, a thiophene ring, a pyridine ring, a thiazole ring, and a benzothiazole ring. Among these, a benzene ring, a thiazole ring, and a benzothiazole ring are preferable.

In addition, in Formula (1), examples of an aromatic ring having 6 or more carbon atoms represented by A includes the examples of the aromatic ring included in Ar¹ described above, and among these, a benzene ring (for example, 1,4-phenyl group) is preferable. Similarly, in Formula (1), examples of a cycloalkylene ring having 6 or more carbon atoms represented by A include a cyclohexane ring, and a cyclohexane ring. Among these, a cyclohexane ring (for example, cyclohexane-1,4-diyl group) is preferable.

Further, in Formula (1), examples of a polymerizable group represented by Q include a (ineth)acryloyl group, a vinyl group, a styryl group, and an allyl group. The term “(meth)acryloyl group” refers to an aeryloyl group or a methacryloyl group.

In the present invention, the liquid crystal compound represented by Formula (1) is preferably a compound having at least three ring structures selected from the group consisting of a benzene ring and a cyclohexane ring for the reason that smectic properties are easily exhibited by pseudo phase separation of the rigid mesogenic moiety and the flexible side chain and sufficient rigidity is exhibited.

In addition, for the same reason, it is preferable that the liquid crystal compound represented by Formula (1) is a liquid crystal compound represented by Formula (1) in which m is 1 or 2.

In the present invention, as the liquid crystal compound represented by Formula (1), for the reason for further improving the durability of the optically anisotropic layer, a compound having two or more polymerizable groups (for example, (meth)acryloyl group, vinyl group, styryl group, and allyl group) is preferable.

Further, in the present invention, the I/O value of the liquid crystal compound represented by Formula (1) is more than 0.56, preferably 0.77 or less, and more preferably 0.60 to 0.71.

Further, in the present invention, the liquid crystal compound represented by Formula (1) is preferably a liquid crystal compound exhibiting reverse wavelength dispersion.

Herein, in this specification, the liquid crystal compound exhibiting “reverse wavelength dispersion” means that at the time of measurement of an in-plane retardation (Re) value at a specific wavelength (visible light range) of a phase difference film prepared using the liquid crystal compound, as the measurement wavelength increases, the Re value becomes equal or higher.

As the liquid crystal compound exhibiting reverse wavelength dispersion, Ar¹ in Formula (I) is preferably a compound which is a divalent aromatic ring group represented by Formula (II-1), (II-2), (II-3), or (II-4). In Formulae (II-1) to (II-4), * represents a bonding position with an oxygen atom.

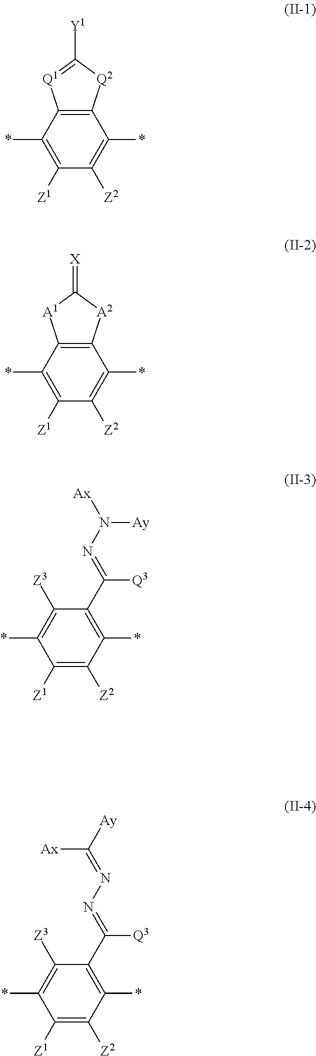

In Formulae (II-1) to II-4), Q¹ represents N or CH, Q² represents —S—, —O—, or —NR¹¹—,R¹¹ represents a hydrogen atom or an alkyl group having 1 to 6 carbon atoms, and Y¹ and represents an aromatic hydrocarbon group having 6 to 12 carbon atoms or an aromatic heterocyclic group having 3 to 12 carbon atoms, which may have a substituent.

Specific examples of the alkyl group having 1 to 6 carbon atoms represented by R¹¹ include a methyl group, an ethyl group, a propyl group, an isopropyl group, a n-butyl group, an isobutyl group, a sec-butyl group, a tert-butyl group, a n-pentyl group, and a n-hexyl group.

Examples of the aromatic hydrocarbon group having 6 to 12 carbon atoms represented by Y¹ include aryl groups such as a phenyl group, a 2,6-diethylphenyl group, and a naphthyl group.

Examples of the aromatic heterocyclic group having 3 to 12 carbon atoms represented by Y¹ include heteroaryl groups such as a thienyl group, a thiazolyl group, a furyl group, and a pyridyl group.

Examples of the substituent that Y¹ may have include a halogen atom, an alkyl group, a halogenated alkyl group, an alkenyl group, an aryl group, a cyano group, an amino group, a nitro group, a nitroso group, a carboxy group, an alkylsuifinyl group having 1 to 6 carbon atoms, an alkylsulfonyl group having 1 to 6 carbon atoms, a fluoroalkyl group having 1 to 6 carbon atoms, an alkoxy group having 1 to 6 carbon atoms, an alkylsulfanyl group having 1 to 6 carbon atoms, an N-alkylamino group having 1 to 6 carbon atoms, an N,N-dialkylamino group having 2 to 12 carbon atoms, an N-alkylsulfamoyl group having 1 to 6 carbon atoms, an N,N-dialkylsulfamoyl group having 2 to 12 carbon atoms, and a combination group thereof.

In addition, in Formulae (II-1) to (II-4), Z¹, Z², and Z³ each independently represent a hydrogen atom, a monovalent aliphatic hydrocarbon group having 1 to 20 carbon atoms, a monovalent alicyclic hydrocarbon group having 3 to 20 carbon atoms, a monovalent aromatic hydrocarbon group having 6 to 20 carbon atoms, a halogen atom, a cyano group, a nitro group, —NR¹³R¹³, or —SR¹⁴, R¹² to R¹⁴each independently represent a hydrogen atom or an alkyl group having 1 to 6 carbon atoms, and Z¹ and Z² may be bonded to each other to foram an aromatic ring.

As the monovalent aliphatic hydrocarbon group having 1 to 20 carbon atoms, an alkyl group having 1 to 15 carbon atoms is preferable and an alkyl group having 1 to 8 carbon atoms is more preferable. Specifically, a methyl group, an ethyl group, an isopropyl group, a tert-pentyl group (1,1-dimethyipropyl group), a tert-butyl group, or a 1,1-dimethyl-3,3-dimethyl-butyl group is still more preferable and a methyl group, an ethyl group, or a tert-butyl group is particularly preferable.

Examples of the monovalent alicyclic hydrocarbon group having 3 to 20 carbon atoms include monocyclic saturated hydrocarbon groups such as a cyclopropyl group, a cyclobutyl group, a cyclopentyl group, a cyclodecyl group, a cycloheptyl group, a cyclooctyl group, a cyclodecyl group, a methylcyclohexyl group, and an ethylcyclohexyl group; monocyclic unsaturated hydrocarbon groups such as a cyclobutenyl group, a cyclopentenyl group, a cyclohexenyl group, a cycloheptenyl group, a cyclooctenyl group, a cyclodeeenyl group, a cyclopentadienyl group, a cyclohexadienyl group, a cyclooctadienyl group, and cyclodecadiene; and polycyclic saturated hydrocarbon groups such as a bicyclo[2.2.1]lieptyl group, a bicyclo[2.2.2]octyl group, a tricyclo[5.2.1.0^{2,6}]decyl group, a tricyclo[3.3.1.1^{3,7}]decyl group, a tetracyclo[6.2.1.1^{3,6}.0^{2,7}]dodecyl group, and an adamantyl group.

Specific examples of the monovalent aromatic hydrocarbon group having 6 to 20 carbon atoms include a phenyl group, a 2,6-diethyiphenyl group, a naphthyl group, and a biphenyl group, and an aryl group having 6 to 12 carbon atoms (particularly a phenyl group) is preferable.

Examples of the halogen atom include a fluorine atom, a chlorine atom, a bromine atom, and an iodine atom, and among these, a fluorine atom, a chlorine atom, or a bromine atom is preferable.

On the other hand, specific examples of the alkyl group having 1 to 6 carbon atoms represented by R¹² to R¹⁴ include a methyl group, an ethyl group, a propyl group, an isopropyl group, a n-butyl group, an isobutyl group, a sec-butyl group, a tert-butyl group, and a n-pentyl group and a n-hexyl group.

In addition, in Formula (II-2), A¹ and A² each independently represent a group selected from the group consisting of —O—, —N(R¹⁵)—, —S—, and —CO—, and R¹⁵ represents a hydrogen atom or a substituent.

Examples of the substituent represented by R¹⁵ include the same substituents that Y¹ may have in Formula (II-1).

In Formula (II-2), X represents a hydrogen atom or a non-metal atom of Groups 14 to 16 to which a substituent may be bonded.

Examples of the non-metal atom of Groups 14 to 16 represented by X include an oxygen atom, a sulfur atom, a nitrogen atom having a substituent, and a carbon atom having a substituent. Examples of the substituent include the same substituents that Y¹ may have in Formula (II-1).

In Formulae (II-3) and (II-4), Ax represents an organic group having 2 to 30 carbon atoms and having at least one aromatic ring selected from the group consisting of an aromatic hydrocarbon ring and an aromatic heterocyclic ring.

In Formulae (II-3) and (II-4), Ay represents a hydrogen atom, an alkyl group having 1 to 6 carbon atoms which may have a substituent, or an organic group having 2 to 30 carbon atoms and having at least one aromatic ring selected from the group consisting of an aromatic hydrocarbon ring and an aromatic heterocyclic ring.

Herein, the aromatic rings in Ax and Ay may respectively have a substituent, Ax and Ay may be bonded to form a ring,

Q³ represents a hydrogen atom or an alkyl group having 1 to 6 carbon atoms which may have a substituent, and

examples of Ax and Ay include ones described in paragraphs [0039] to [0095] of WO2014/010325A.

Specific examples of the alkyl group having 1 to 6 carbon atoms represented by Q³ include a methyl group, an ethyl group, a propyl group, an isopropyl group, a n-butyl group, an isobutyl group, a sec-butyl group, a tert-butyl group, and a n-pentyl group and a n-hexyl group. Examples of the substituent include the same substituents that Y¹ may have in Formula (II-1).

Preferable examples of the liquid crystal compounds represented by Formulae (II-1) to (II-4) are shown below. However, the present invention is not limited to these liquid crystal compounds. In the formulae, all 1,4-cyclohexylene groups are trans-1,4-cyclohexylene groups.

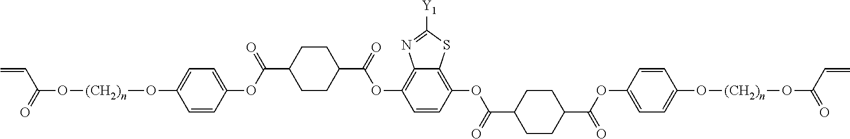

| No | Y1 | n |
|---|---|---|
| II-1-1 | 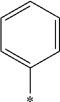 [SMILES: *c1ccccc1] | 6 |
| II-1-2 | 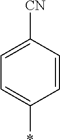 [SMILES: *c1ccc(C#N)cc1] | 6 |
| II-1-3 | 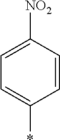 [SMILES: *c1ccc([N+](=O)[O-])cc1] | 6 |
| II-1-4 | 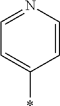 [SMILES: *c1ccncc1] | 6 |
| II-1-5 | 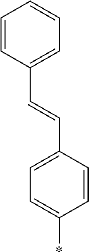 [SMILES: *c1ccc(/C=C/c2ccccc2)cc1] | 6 |
| II-1-6 | 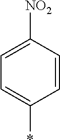 [SMILES: *c1ccc([N+](=O)[O-])cc1] | 11 |
| II-1-7 | 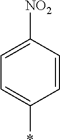 [SMILES: *c1ccc([N+](=O)[O-])cc1] | 8 |
| II-1-8 | 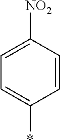 [SMILES: *c1ccc([N+](=O)[O-])cc1] | 4 |
| II-1-9 | 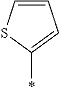 [SMILES: *c1cccs1] | 6 |
| II-1-10 | 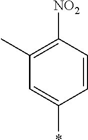 [SMILES: *c1ccc([N+](=O)[O-])c(C)c1] | 6 |
| II-1-11 | 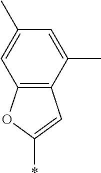 [SMILES: *c1cc2c(C)cc(C)cc2o1] | 6 |
| II-1-12 | 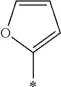 [SMILES: *c1ccco1] | 6 |
| II-1-13 | 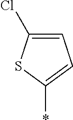 [SMILES: *c1ccc(Cl)s1] | 6 |
| II-1-14 | 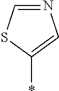 [SMILES: *c1cncs1] | 6 |
| II-1-15 | 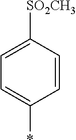 [SMILES: *c1ccc(S(C)(=O)=O)cc1] | 6 |

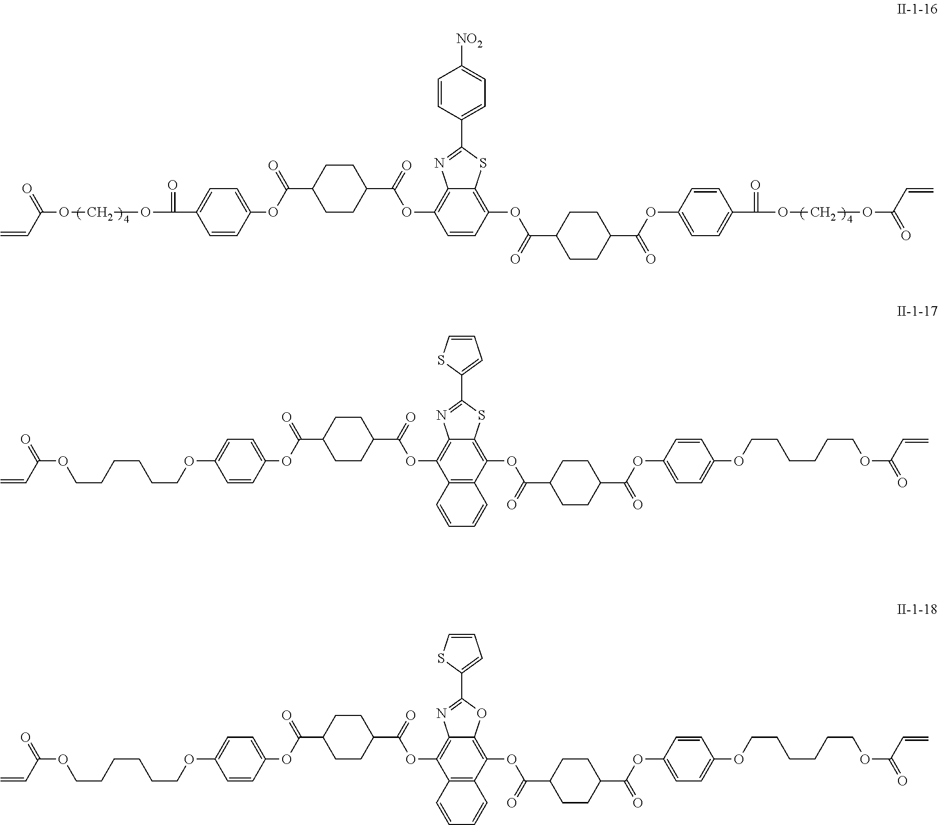

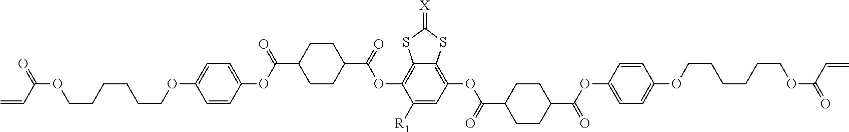

| No | X | R1 |
|---|---|---|
| II-2-1 | 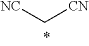 | H |
| II-2-2 | 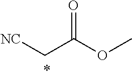 | H |
| II-2-3 | 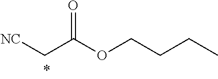 | H |
| II-2-4 | 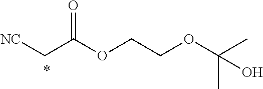 | H |
| II-2-5 | 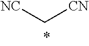 | CH₃ |
| II-2-6 | 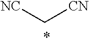 | 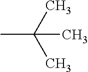 |
| II-2-7 | S | H |

In the formulae, “*” represents a bonding position.

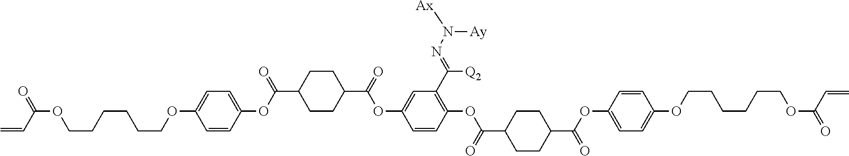

| No | Ax | Ay | Q2 |
|---|---|---|---|
| II-3-1 | 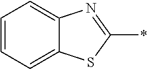 [SMILES: *c1nc2ccccc2s1] | H | H |
| II-3-2 | 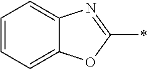 [SMILES: *c1nc2ccccc2o1] | H | H |
| II-3-3 | 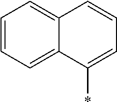 [SMILES: *c1cccc2ccccc12] | H | H |
| II-3-4 | Ph | Ph | H |
| II-3-5 | 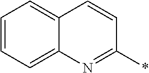 [SMILES: *c1ccc2ccccc2n1] | H | H |
| II-3-6 | 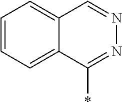 [SMILES: *c1nncc2ccccc12] | H | H |
| II-3-7 | 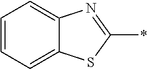 [SMILES: *c1nc2ccccc2s1] | CH₃ | H |
| II-3-8 | 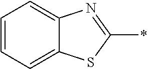 [SMILES: *c1nc2ccccc2s1] | C₄H₉ | H |
| II-3-9 | 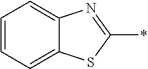 [SMILES: *c1nc2ccccc2s1] | C₆H₁₃ | H |
| II-3-10 | 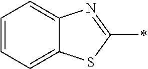 [SMILES: *c1nc2ccccc2s1] | 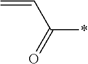 [SMILES: *C(=O)C=C] | H |
| II-3-11 | 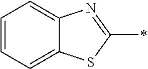 [SMILES: *c1nc2ccccc2s1] | 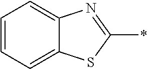 [SMILES: *c1nc2ccccc2s1] | H |
| II-3-12 | 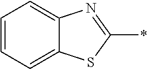 [SMILES: *c1nc2ccccc2s1] | CH₂CN | H |
| II-3-13 | 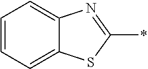 [SMILES: *c1nc2ccccc2s1] | 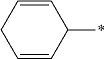 [SMILES: *C1C=CCC=C1] | H |
| II-3-14 | 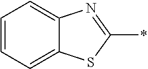 [SMILES: *c1nc2ccccc2s1] | 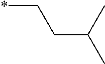 [SMILES: *CCC(C)C] | H |
| II-3-15 | 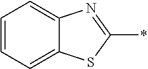 [SMILES: *c1nc2ccccc2s1] | CH₂CH₂OH | H |
| II-3-16 | 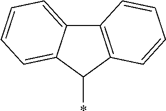 [SMILES: *C1c2ccccc2-c2ccccc21] | H | H |
| II-3-17 | 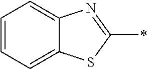 [SMILES: *c1nc2ccccc2s1] | CH₂CF₃ | H |
| II-3-18 | 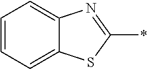 [SMILES: *c1nc2ccccc2s1] | H | CH₃ |
| II-3-19 | 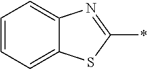 [SMILES: *c1nc2ccccc2s1] | 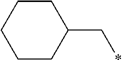 [SMILES: *CC1CCCCC1] | H |
| II-3-20 | 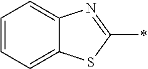 [SMILES: *c1nc2ccccc2s1] | 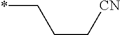 [SMILES: *CCCC#N] | H |
| II-3-21 | 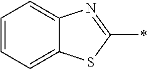 [SMILES: *c1nc2ccccc2s1] | 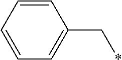 [SMILES: *Cc1ccccc1] | H |
| II-3-22 | 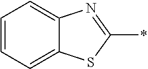 [SMILES: *c1nc2ccccc2s1] | 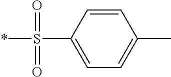 [SMILES: *S(=O)(=O)c1ccc(C)cc1] | H |
| II-3-23 | 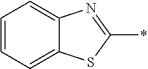 [SMILES: *c1nc2ccccc2s1] | 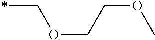 [SMILES: *COCCOC] | H |
| II-3-24 | 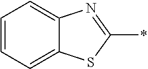 [SMILES: *c1nc2ccccc2s1] | 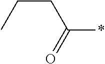 [SMILES: *C(=O)CCC] | H |
| II-3-25 | 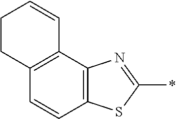 [SMILES: *c1nc2c3c(ccc2s1)CCC=C3] | C₆H₁₃ | H |

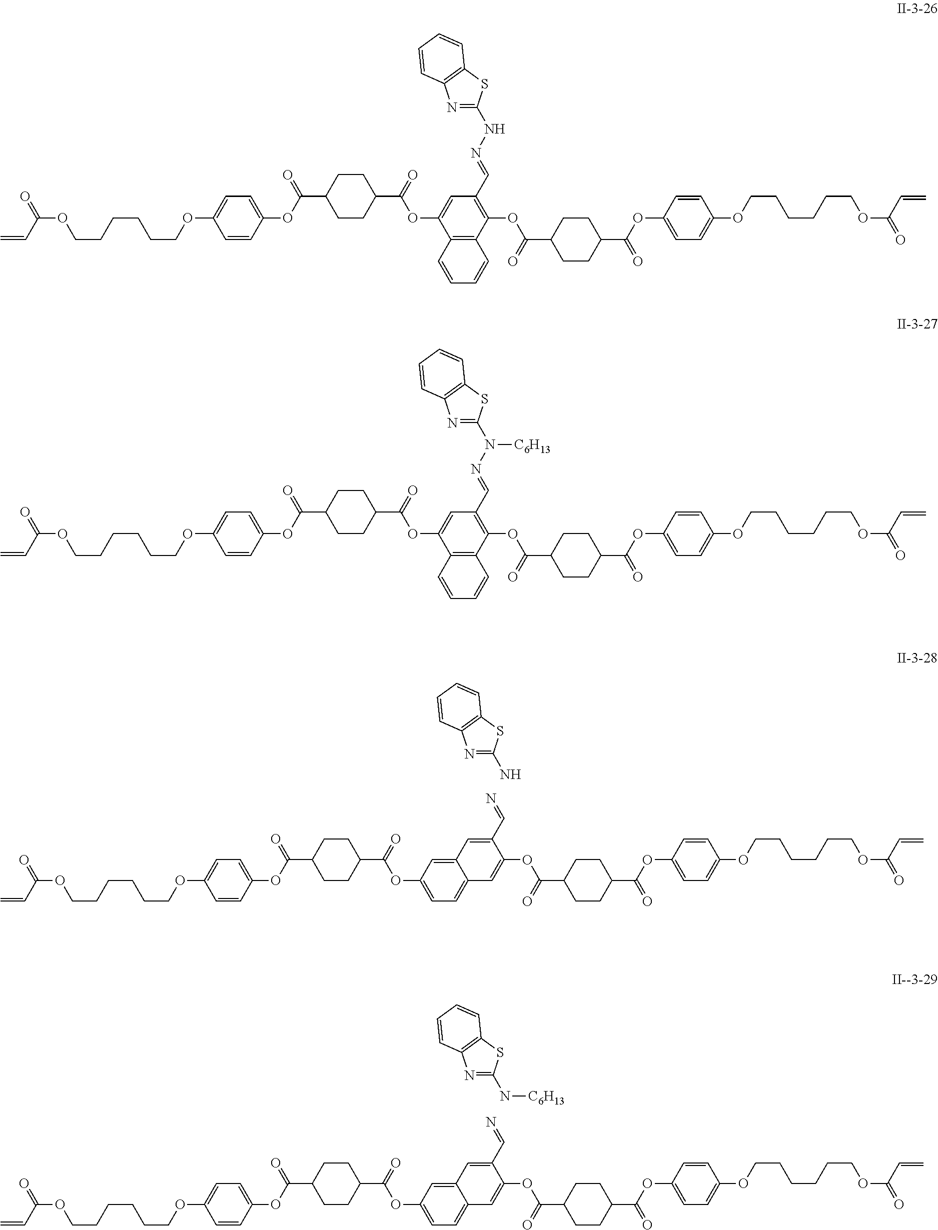

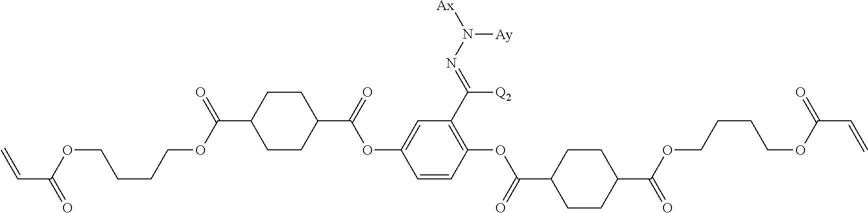

| No | Ax | Ay | Q2 |
|---|---|---|---|
| II-3-30 | 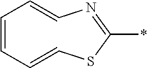 [SMILES: */C1=N/C=C/C=C\C=C\S1] | H | H |
| II-3-31 | 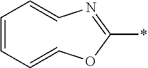 [SMILES: */C1=N/C=C/C=C\C=C\O1] | H | H |
| II-3-32 | 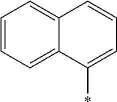 [SMILES: *c1cccc2ccccc12] | H | H |
| II-3-33 | Ph | Ph | H |
| II-3-34 | 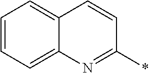 [SMILES: *c1ccc2ccccc2n1] | H | H |
| II-3-35 | 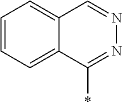 [SMILES: *c1nncc2ccccc12] | H | H |
| II-3-36 | 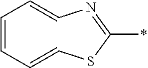 [SMILES: */C1=N/C=C/C=C\C=C\S1] | CH₃ | H |
| II-3-37 | 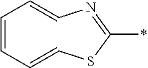 [SMILES: */C1=N/C=C/C=C\C=C\S1] | C₄H₉ | H |
| II-3-38 | 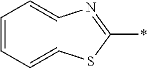 [SMILES: */C1=N/C=C/C=C\C=C\S1] | C₆H₁₃ | H |
| II-3-39 | 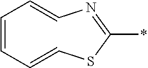 [SMILES: */C1=N/C=C/C=C\C=C\S1] | 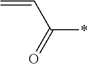 [SMILES: *C(=O)C=C] | H |
| II-3-40 | 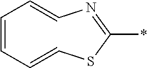 [SMILES: */C1=N/C=C/C=C\C=C\S1] | 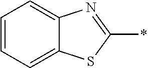 [SMILES: *c1nc2ccccc2s1] | H |
| II-3-41 | 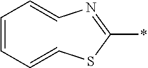 [SMILES: */C1=N/C=C/C=C\C=C\S1] | CH₂CN | H |
| II-3-42 | 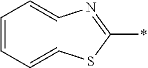 [SMILES: */C1=N/C=C/C=C\C=C\S1] | 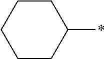 [SMILES: *C1CCCCC1] | H |
| II-3-43 | 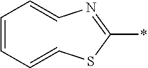 [SMILES: */C1=N/C=C/C=C\C=C\S1] | 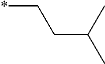 [SMILES: *CCC(C)C] | H |
| II-3-46 | 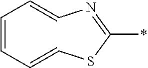 [SMILES: */C1=N/C=C/C=C\C=C\S1] | CH₂CH₂OH | H |
| II-3-45 | 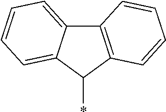 [SMILES: *C1c2ccccc2-c2ccccc21] | H | H |
| II-3-46 | 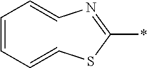 [SMILES: */C1=N/C=C/C=C\C=C\S1] | CH₂CF₃ | H |
| II-3-47 | 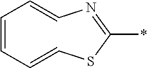 [SMILES: */C1=N/C=C/C=C\C=C\S1] | H | CH₃ |
| II-3-48 | 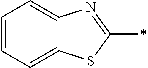 [SMILES: */C1=N/C=C/C=C\C=C\S1] | 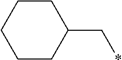 [SMILES: *CC1CCCCC1] | H |
| II-3-49 | 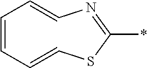 [SMILES: */C1=N/C=C/C=C\C=C\S1] | 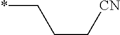 [SMILES: *CCCC#N] | H |
| II-3-50 | 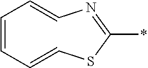 [SMILES: */C1=N/C=C/C=C\C=C\S1] | 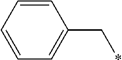 [SMILES: *Cc1ccccc1] | H |
| II-3-51 | 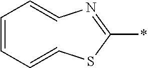 [SMILES: */C1=N/C=C/C=C\C=C\S1] | 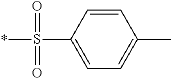 [SMILES: *S(=O)(=O)c1ccc(C)cc1] | H |
| II-3-52 | 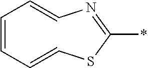 [SMILES: */C1=N/C=C/C=C\C=C\S1] | 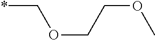 [SMILES: *COCCOC] | H |
| II-3-53 | 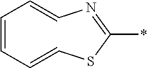 [SMILES: */C1=N/C=C/C=C\C=C\S1] | 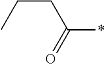 [SMILES: *C(=O)CCC] | H |
| II-3-54 | 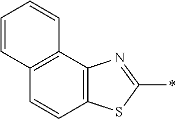 [SMILES: *c1nc2c(ccc3ccccc32)s1] | C₆H₁₃ | H |

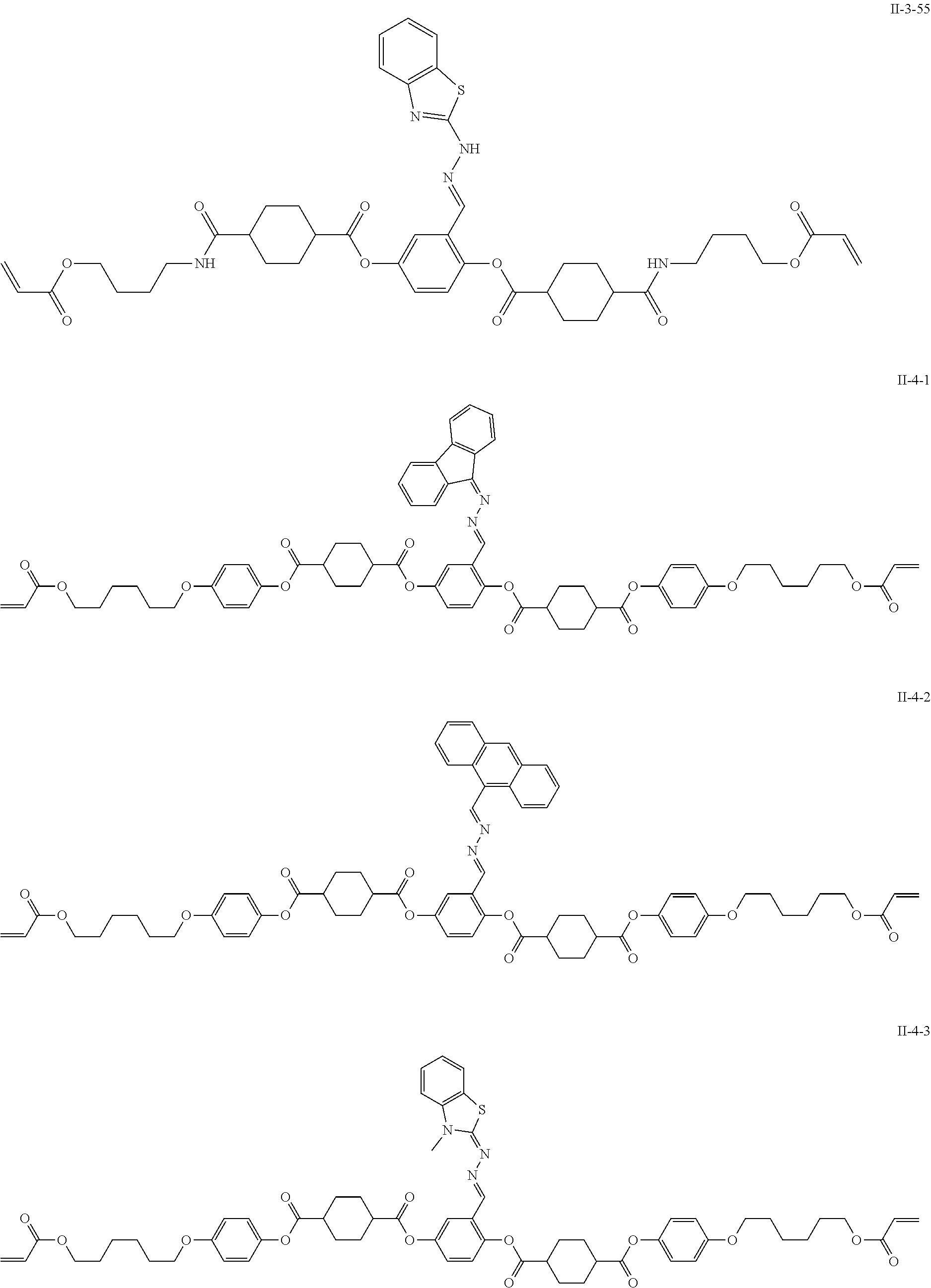

Further, in the present invention, as the liquid crystal compound represented by Formula (1), for the reason for further improving the durability of the optically anisotropic layer by electronic interaction between liquid crystal molecules, Ar¹ in Formula (1) is preferably a compound represented by Formula (II-2). Specifically, it is more preferable that n in Formula (1) is 2 and Ar¹ is a compound represented by Formula (1a).

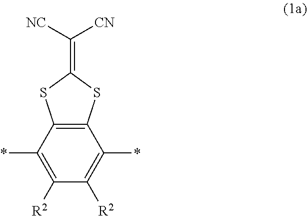

Herein, in Formula (1a), * represents a bonding position, and R²'s each independently represent a hydrogen atom or an alkyl group having 1 to 6 carbon atoms.

Examples of a compound in which n in Formula (1) is 2 and Ar¹ is a compound represented by Formula (1a) include a compound represented by Formula L-1 (liquid crystal compound L-1), a compound represented by Formula L-2 (liquid crystal compound L-2), a compound represented by Formula L-3 (liquid crystal compound L-3), a compound represented by Formula L-4 (liquid crystal compound L-4), and a compound represented by Formula L-5 (liquid crystal compound L-5). A. group adjacent to an acryloyl oxy group in Formulae L-1 and L-2 represents a propylene group (a group in which a methyl group is substituted with an ethylene group), and the liquid crystal compounds L-1 and L-2 represent mixtures of positional isomers in which the positions of methyl group are different.

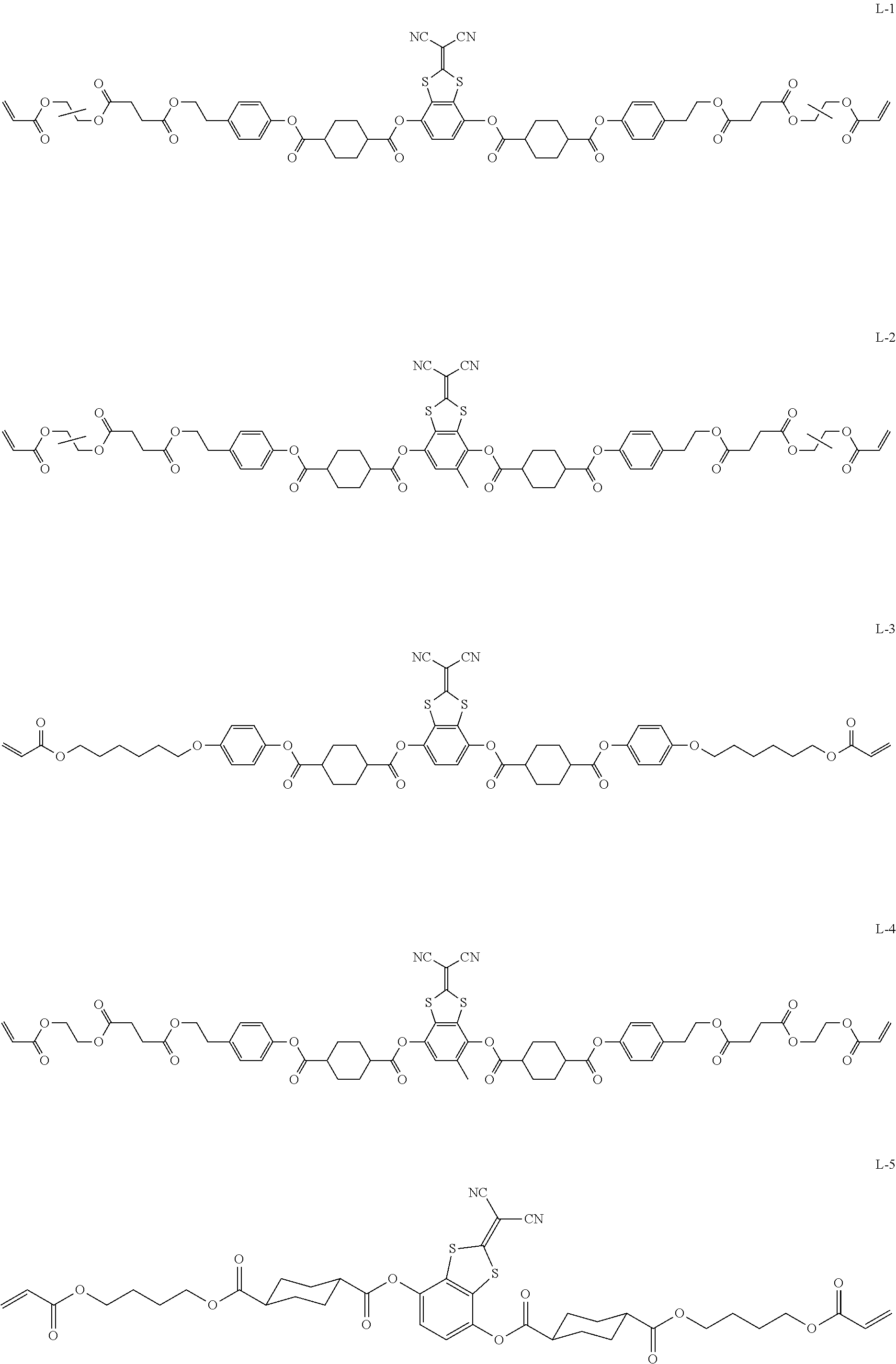

<Mesogen Compound>

The polymerizable liquid crystal composition for forming the optically anisotropic layer includes a mesogen compound having two or more polymerizable groups and an I/O value of 0.56 or less.

Here, in the present specification, the term “mesogen compound” refers to a compound having a mesogen group in a molecule and may be a compound exhibiting liquid crystallinity by itself and may be a compound exhibiting liquid crystallinity by being mixed with the above-described liquid crystal compound.

In addition, the polymerizable group of the mesogen compound is not particularly limited and examples thereof include a (meth)acryloyl group, a vinyl group, a styryl group, and an allyl group. Among these, it is preferable that the mesogen compound has a (meth)acryloyl group.

The mesogen group of the mesogen compound is not particularly limited and various structures can be used.

As the mesogen group, a group represented by Formula (MG-I) is preferable.

-(Q¹-Z¹)ₖ-(Q²-Z²)ₗ-Q⁵-(Z³-Q³)ₘ-(Q⁴-Z⁴)ₙ— MG-I:

In the formula, Q¹, Q², Q³, Q⁴, and Q⁵ each independently represent a 1,4-phenylene group (hereinafter, also referred to as “benzene ring”), a heterocyclic group in which one or two or more CH groups of a 1,4-phenylene group are substituted with N, a 1,4-cyclohexylene group (hereinafter also referred to as “cyclohexane ring”), a heterocyclic group in which one CH₂ group or non-adjacent two CH₂ groups of a 1,4-cyclohexylene group may be substituted with O and/or S, a 1,4-cyclohexenylene group, or a naphthalene-2,6-diyl group. These groups may have a substituent. Among these, it is preferable that Q⁵ represents a benzene ring, Q¹, Q², Q³ and Q⁴ each independently represent a benzene ring or a cyclohexane ring from the viewpoint of costs or the like.

In addition, in the formula, Z¹, Z², Z³, and Z⁴ each independently represent —COO—, —OCO—, —COOCH₂CH₂—, —CH₂CH₂OCO—, —CH₂CH₂—, —OCH₂—, —CH₂O—, —CH═CH—, —C≡C, —CH═CH—COO—, —OCO—CH═CH—, —NH═CH₂—, —CH₂═NH—, —SCO—, —OCS—, or a single bond. Among these, from the viewpoint of costs or the like, —COO—, —OCO—, —COOCH₂CH₂—, or —CH₂CH₂OCO— is preferable.

In addition, in the formula, k, l, m, and n each independently represent an integer of 0 to 2, and a total of k, l, m, and n is preferably an inteaer of 2 to 4, and more preferably 4.

The mesogen compound may have the group represented by Formula (MG-I) at two or more places in one molecule.

In the present invention, the I/O value of the mesogen compound is 0.56 or less and preferably 0.35 to 0.56.

In addition, for the reason for improving the contrast of an image display device having the optical film of the present invention while maintaining excellent durability of the optically anisotropic layer, a difference between the I/O value of the above-described liquid crystal compound (the I/O value of each liquid crystal compound in a case of using two or more liquid crystal compounds in combination) and the I/O value of the mesogen compound is preferably more than 0 and 0.15 or less, and more preferably more than 0 and 0.1 or less. It is considered that this is because the affinity between the liquid crystal compound and the mesogen compound becomes satisfactory and the network structure is dense.

In the present invention, for the reason for further improving the durability of the optically anisotropic layer, the mesogen compound preferably has at least one ring structure selected from the group consisting of a benzene ring and a cyclohexane ring, more preferably has 3 to 5 ring structures, and even more preferably has 5 ring structures.

In addition, for the reason for further improving the durability of the optically anisotropic layer, the number of cyclohexane rings in the mesogen compound is preferably 2 or less, more preferably 1 or less, and even more preferably 0 in the mesogen compound. That is, the above-described ring structure is preferably constituted of a benzene ring.

In the present invention, the mesogen compound is preferably a liquid crystal compound exhibiting forward wavelength dispersion.

Here, in the present specification, regarding the liquid crystal compound exhibiting “forward wavelength dispersion”, as the measurement wavelength in a case of measuring an in-plane retardation (Re) value at a specific wavelength (visible light range) of a phase difference film prepared using the compound becomes longer, the Re value becomes smaller.

Examples of such a mesogen compound include compounds represented by Formula (M2) and Formula (M3) described in paragraphs [0032] and [0033] of JP2014-077068A and specific examples thereof include specific examples described in paragraphs [0050] to [0055] of JP2014-077068A.

In the present invention, the content of the mesogen compound is not particularly limited and for the reason for further improving the durability of the optically anisotropic layer, content of the mesogen compound is preferably 4% by mass or more, more preferably 4% to 30% by mass, and even more preferably 10% to 20% by mass with respect to toe total mass of the above-described liquid crystal compound and the mesogen compound.

<Polymerization Initiator>

The polymerizable liquid crystal composition forming the optically anisotropic layer includes a polymerization initiator.

The polymerization initiator to be used is preferably a photopolymerization initiator that can initiate a polymerization reaction by irradiation with ultraviolet rays.

Examples of the photopolymerization initiator include a-carbonyl compounds (described in U.S. Pat. No. 2,367,661A and U.S. Pat. no. 2,367,670A), acyloin ethers (described in U.S. Pat. No. 2,448,828A), a-hydrocarbon-substituted aromatic acyloin compounds (described in U.S. Pat. No. 2,722,512A), multinuclear quinone compounds (as described in US3046127A and US2951758A), combinations of triarylimidazole dimer and p-aminophenyl ketone (as described in U.S. Pat. No. 3,549,367A), acridine and phenazine compounds (described in JP1985-105667A (JP-S60-105667A) and U.S. Pat. No. 4,239,850A), oxadiazole compounds (described in U.S. Pat. No. 4,212,970A), and acyl phosphine oxide compounds (described in JP1988-40799B (JP-S63-40799B), JP1993-29234B (JP-H05-29234B), JP1998-95788A (JP-H10-95788A), and JP1998-29997A (JP-H10-29997A)).

In the present invention, for the reason for further improving the durability of the optically anisotropic layer, the polymerization initiator is preferably an oxime type polymerization initiator, and specifically, the polymerization initiator is more preferably an oxime type polymerization initiator represented by Formula (2).

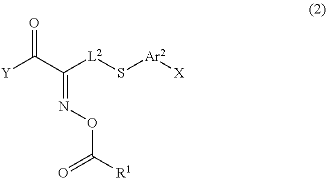

Herein, in Formula (2), X represents a hydrogen atom or a halogen atom, and

Ar² represents a divalent aromatic group, L² represents a divalent organic group having 1 to 12 carbon atoms,

R′ represents an alkyl group having 1 to 12 carbon atoms, and Y represents a monovalent organic group.

In Formula (2), examples of the halogen atom represented by X include a fluorine atom, a chlorine atom, a bromine atom, and an iodine atom, and among them, a chlorine atom is preferable.

In addition, as the divalent aromatic group represented by Ar² in Formula (2), a divalent group having at least one aromatic ring selected from the group consisting of the aromatic hydrocarbon ring and the aromatic heterocyclic ring exemplified as Ar¹ in Formula (1) may be used.

In addition, examples of the divalent organic group in Formula (2), having 1 to 12 carbon atoms represented by L² include a linear or branched alkylene group having 1 to 12 carbon atoms. Specifically, a methylene group, an ethylene group, a propylene group, and the like may be suitably used.

In addition, in Formula (2), specifically suitable examples of the alkyl group having 1 to 12 carbon atoms represented by R¹ includes a methyl group, an ethyl group, and a propyl group.

Further, in Formula (2), examples of the monovalent organic group represented by Y include functional groups including a benzophenone skeleton ((C6H₅)₂CO). Specifically, like the groups represented by Formulae (2a) and (2b), functional groups including a benzophenone skeleton in which a benzene ring at the terminal is unsubstituted or has one substituent are preferable.

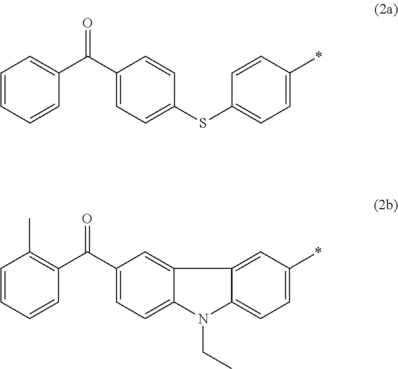 [SMILES: *c1ccc(Sc2ccc(C(=O)c3ccccc3)cc2)cc1 ; *c1ccc2c(c1)c1cc(C(=O)c3ccccc3C)ccc1n2CC]

Herein, in Formulae (2a) and (2b), * represents a bonding position, that is, a bonding position with the carbon atom of the carbonyl group in Formula (2).

Examples of the oxime type polymerization initiator represented by Formula (2) include a compound represented by Formula S-1 and a compound represented by Formula S-2.

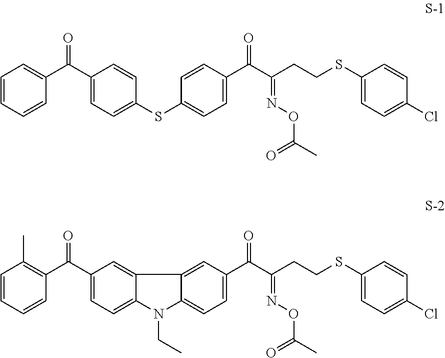 [SMILES: CC(=O)O/N=C(\CCSc1ccc(Cl)cc1)C(=O)c1ccc(Sc2ccc(C(=O)c3ccccc3)cc2)cc1 ; CCn1c2ccc(C(=O)/C(CCSc3ccc(Cl)cc3)=N/OC(C)=O)cc2c2cc(C(=O)c3ccccc3C)ccc21]

In the present invention, the content of the polymerization initiator is not particularly limited. However, the solid content of the polymerizable liquid crystal composition is preferably 0.01% to 20% by mass and more preferably 0.5% to 5% by mass.

<Oraanic Solvent>

The polymerizable liquid crystal composition forming the optically anisotropic layer preferably contains an organic solvent from the viewpoint of workability for forming the optically anisotropic layer and the like.

Specific examples of the organic solvent include ketones (such as acetone, 2-butanone, methyl isobutyl ketone, and cyclohexanone), ethers (such as dioxane and tetrahydrofuran), aliphatic hydrocarbons (such as hexane), alicyclic hydrocarbons (such as cyclohexane), aromatic hydrocarbons (such as toluene, xylene, and trimethylhenzene), halogenated carbons (such as dichloromethane, dichloroethane, dichlorobenzene, and chlorotoluene), esters (such as methyl acetate, ethyl acetate, and butyl acetate), water, alcohols (such as ethanol, isopropanol, butanol, and cyclohexanol), cellosolves (such as methyl cellosolve and ethyl cellosolve), cellosolve acetates, sulfoxides (such as dimethyl sulfoxide), and amides (such as dimethylformamide and dimethylacetamide). These may be used alone or may be used in combination of two or more kinds.

In the present invention, as the method of forming the optically anisotropic layer, for example, a method in which a desired alignment state is obtained using the polymerizable liquid crystal composition containing an arbitrary polymerizable compound and an organic solvent in addition to the above-described liquid crystal compound, the inesogen compound, and polymerization initiator and then the alignment state is fixed by polymerization, and the like may be used.

Herein, the polymerization conditions are not particularly limited and in the polymerization by photoirradiation, ultraviolet (UV) rays are preferably used. The irradiation dose is preferably 10 mJ/cm² to 50 J/cm², more preferably 20 mJ/cm² to 5 J/cm², still more preferably 30 mJ/cm² to 3 J/cM², and particularly preferably 50 to 1,000 mJ/cm². In addition, in order to promote the polymerization reaction, the polymerization may be carried out under a heating condition.

In the present invention, the optically anisotropic layer can be formed on an arbitrary support described later or a polarizer of a polarizing plate of the present invention described later.

In addition, in the present invention, for the reason for improving the contrast of an image display device, the optically anisotropic layer is preferably a layer that can be obtained by aligning the above-described polymerizable liquid crystal composition in a smectic phase and then polymerizing (fixing the alignment) the compound. It is considered that this is because the degree of order of the smectic phase is higher than that of a nematic phase and scattering caused by the alignment disorder of the optically anisotropic layer is suppressed.

In addition, the optically anisotropic layer of the optical film of the present invention preferably satisfies Expression (I) from the viewpoint of imparting excellent viewing angle properties.

0.75≤Re(450)/Re(550)≤1.00 (I)

Herein, in Expression (I), Re(450) represents an in-plane retardation of the optically anisotropic layer at a wavelength of 450 nm, and Re(550) represents an in-plane retardation of the optically anisotropic layer at a wavelength of 550 nm.

In addition, the in-plane retardation value refers to a value measured with light at the measurement wavelength using an automatic birefringence meter (KOBRA-21ADH, manufactured by Oji Scientific Instruments).

In the present invention, although the thickness of the optically anisotropic layer is not particularly limited, the thickness thereof is preferably 0.1 to 10 μm and more preferably 0.5 to 5 μm.

[Support]

The optical film of the present invention may have a support as a substrate for forming the optically anisotropic layer as described above.

Such a support is preferably transparent and specifically, the support preferably has a light transmittance of 80% or more.

Examples of such a support include glass substrates and polymer films. Examples of the material for the polymer film include cellulose-based polymers; acrylic polymers having acrylic ester polymers such as polymethyl methacrylate, and lactone ring-containing polymers; thermoplastic norbomene-based polymers; polycarbonate-based polymers; polyester-based polymers such as polyethylene terephthalate and polyethylene naphthalate; styrene-based polymers such as polystyrene and acrylonitrile-styrene copolymers (AS resin); polyolefin-based polymers such as polyethylene, polypropylene, and ethylene-propylene copolymers; vinyl chloride-based polymers; amide-based polymers such as nylon and aromatic polyamide; imide-based polymers; sulfone-based polymers; polyether sulfone-based polymers; polyether ether ketone-based polymers; polyphenylene sulfide-based polymers; vinylidene chloride-based polymers; vinyl alcohol-based polymers; vinyl butyral-based polymers; arylate-based polymers; polyoxymethylene-based polymers; epoxy-based polymers; and polymers containing a mixture of these polymers.

In addition, the polarizer which will be described later may function as such a support.

In the present invention, although the thickness of the support is not particularly limited, the thickness thereof is preferably 5 to 60 μm and more preferably 5 to 30 μm.

[Alignment Film]

In the case in which the optical film has the above-described arbitrary support, the optical film of the present invention preferably has an alignment film between the support and the optically anisotropic layer. The above-described support may function as an alignment film.

The alignment film generally has a polymer as a main component. The materials for the polymer material for an alignment film are described in many documents and many commercially available products can be used.

The polymer material used in the present invention is preferably a polyvinyl alcohol, or a polyimide, or a derivative thereof. Particularly, a modified or non-modified polyvinyl alcohol is preferable.

Examples of alignment films that can be used in the present invention include alignment films described in Line 24 on Page 43 to Line 8 on Page 49 of WO01/88574A; modified polyvinyl alcohols described in paragraphs [0071] to [0095] of JP3907735B; and a liquid crystal alignment film formed by a liquid crystal aligning agent described in JP2012-155308A.

In the present invention, for the reason that surface state deterioration can be prevented by avoiding a contact with the surface of the alignment film at the time of forming the alignment film, an optical alignment film is preferably used as the alignment film.

Although the optical alignment film is not particularly limited, polymer materials such as polyamide compounds and polyimide compounds described in paragraphs [0024] to [0043] of WO2005/096041A; a liquid crystal alignment film formed by a liquid crystal aligning agent having a photo-aligned group described in JP2012-155308A; and LPP-JP265CP, product name, manufactured by Rolic technologies Ltd. can be used.

In addition, in the present invention, although the thickness of the alignment film is not particularly limited, from the viewpoint of forming an optically anisotropic layer having a uniform film thickness by alleviating the surface roughness present on the support, the thickness thereof is preferably 0.01 to 10 μ, more preferably 0.01 to 1 μm, and still more preferably 0.01 to 0.5 μm.

[Hard Coat Layer]

The optical film of the present invention preferably has a hard coat layer for imparting film physical strength. Specifically, the hard coat layer may be provided on the side of the support opposite to the side on which the alignment film is provided (refer to FIG. 1B) or may be provided on the side of the optically anisotropic layer opposite to the side on which the alignment film is provided (refer to FIG. 1C).

As the hard coat layer, layers described in paragraphs [0190] to [0196] of JP2009-98658A can be used.

[Other Optically Anisotropic Layers]

The optical film of the present invention may have optically anisotropic layers other than the layer obtained by polymerizing the above-described polymerizable liquid crystal composition containing the liquid crystal compound represented by Formula (1), the tnesogen compound, and the polymerization initiator (hereinafter, formally referred to as “optically anisotropic layer of the present invention” in the paragraph). That is, the optical film of the present invention may have a laminated structure of the optically anisotropic layer of the present invention and other optically anisotropic layers.

Such other optically anisotropic layers are not particularly limited as long as the optically anisotropic layers include liquid crystal compounds other than the above-described liquid crystal compound represented by Formula (1) and/or polymerizable compounds other than the above-described mesogen compound.

Here, generally, liquid crystal compounds are classified into a rod-like type and a disk-like type according to the shape thereof. Further, each includes a low molecular type and a high molecular type. The term “high molecular” generally refers to a compound having a degree of polymerization of 100 or more (Polymer Physics-Phase Transition Dynamics, by Masao Doi, p. 2, published by Iwanami Shoten, Publishers, 1992). In the present invention, any type of liquid crystal compound can be used, but a rod-like liquid crystal compound or a discotic liquid crystal compound (disk-like liquid crystal compound) is preferably used. Two or more kinds of rod-like liquid crystal compounds, two or more kinds of disk-like liquid crystal compounds, or a mixture of a rod-like liquid crystal compound and a disk-like liquid crystal compound may be used. In order to fix the above-described liquid crystal compound, the optically anisotropic layer is more preferably formed using a rod-like liquid crystal compound or disk-like liquid crystal compound having a polymerizable group, and the liquid crystal compound still more preferably has two or more polymerizable groups in one molecule In the case of a mixture of two or more kinds of the liquid crystal compounds, at least one kind of liquid crystal compound preferably has two or more polymerizable groups in one molecule.

As the rod-like liquid crystal compound, for example, the rod-like liquid crystal compounds described in claim 1 of JP1999-513019A (JP-H11-513019A) or paragraphs [0026] to [0098] of JP2005-289980A can be preferably used, and, as the discotic liquid crystal compounds, for example, the discotic liquid crystal compounds described in paragraphs [0020] to [0067] of JP2007-108732A and paragraphs [0013] to [0108] of JP2010-244038A can be preferably used, but the liquid crystal compounds are not limited thereto.

[Ultraviolet Absorbent]

The optical film of the present invention preferably includes an ultraviolet (UV) absorbent in consideration of effect of external light (particularly, ultraviolet rays) and more preferably includes an ultraviolet absorbent in the support.

As the ultraviolet absorbent, any of known ultraviolet absorbents can be used since ultraviolet absorbency can be exhibited. Among these ultraviolet absorbents, in order to obtain a high ultraviolet absorbency and ultraviolet absorptivity (ultraviolet cutting ability) used for an electronic image display device, a benzotriazcle-based or hydroxyphenyl triazine-based ultraviolet absorbent is preferable. In addition, in order to widen the ultraviolet absorption width, two or more kinds of ultraviolet absorbents having different maximum absorption wavelengths can be used in combination.

[Polarizing Plate]

A polarizing plate of the present invention has the above-described optical film of the present invention and a polarizer.

[Polarizer]

The polarizer of the polarizing plate of the present invention is not particularly limited as long as the polarizer is a member having a function of converting light into specific linearly polarized light, and conventionally known absorptive type polarizer and reflective type polarizer can be used.

An iodine-based polarizer, a dye-based polarizer using a dichroic dye, a polyene-based polarizer, and the like are used as the absorptive type polarizer. The iodine-based polarizer and the dye-based polarizer are a coating type polarizer and a stretching type polarizer, any one of these polarizers can be applied. However, a polarizer which is prepared by allowing polyvinyl alcohol to adsorb iodine or a dichroic dye and performing stretching is preferable.

In addition, examples of a method of obtaining a polarizer by performing stretching and dyeing in a state of a laminated film in which a polyvinyl alcohol layer is formed on a substrate include methods disclosed in JP5048120B, JP5143918B, JP4691205B, JP4751481B, and JP4751486B, and known technologies related to these polarizers can be preferably used.

A polarizer in which thin films having different birefringence are laminated, a wire grid type polarizer, a polarizer in which a cholesteric liquid crystal having a selective reflection range and a ¼ wavelength plate are combined, and the like are used as the reflective type polarizer.

Among these, a polarizer containing a polyvinyl alcohol-based resin (a polymer including —CH₂—CHOH— as a repeating unit, in particular, at least one selected from the group consisting of polyvinyl alcohol and an ethylene-vinyl alcohol copolymer) is preferable.

In the present invention, although the thickness of the polarizer is not particularly limited, the thickness thereof is preferably 3 μm to 60 μm, more preferably 5 μm to 30 μm, and still more preferably 5 μm to 15 μm.

[Pressure Sensitive Adhesive Layer]

The polarizing plate of the present invention may have a pressure sensitive adhesive layer arranged between the optically anisotropic layer in the optical film of the present invention and the polarizer.

The pressure sensitive adhesive layer used for lamination of the optically anisotropic layer and the polarizer is, for example, a substance in which a ratio between storage elastic modulus G′ and loss elastic modulus G″ (tans δ=G″/G′) is 0.001 to 1.5, where G′ and G″ are measured with a dynamic viscoelastometer. Such a substance includes a so-called pressure sensitive adhesive or readily creepable substance. As the pressure sensitive adhesive that can be used in the present invention, for example, a polyvinyl alcohol-based pressure sensitive adhesive may be used, but there is no limitation thereto.

[Image Display Device]

An image display device of the present invention is an image display device having the optical film of the present invention or the polarizing plate of the present invention.

The display element used for the image display device of the present invention is not particularly limited and examples thereof include a liquid crystal cell, an organic electroluminescent (hereinafter, abbreviated as “EL”) display panel, and a plasma display panel.

Among these, a liquid crystal cell and an organic EL display panel are preferable, and a liquid crystal cell is more preferable. That is, for the image display device of the present invention, a liquid crystal display device using a liquid crystal cell as a display element, and an organic EL display device using an organic EL display panel as a display element are preferable and a liquid crystal display device is more preferable.

[Liquid Crystal Display Device]

A liquid crystal display device as an example of the image display device of the present invention is a liquid crystal display device including the above-described polarizing plate of the present invention and a liquid crystal cell.

In the present invention, it is preferable that the polarizing plate of the present invention is used for the polarizing plate of the front side, out of the polarizing plates provided on the both sides of the liquid crystal cell, and it is more preferable that the polarizing plate of the present invention is used for the polarizing plates on the front and rear sides.

Hereinafter, the liquid crystal cell constituting the liquid crystal display device will be described in detail.

<Liquid Crystal Cell>

The liquid crystal cell for use in the liquid crystal display device is preferably of a vertical alignment (VA) mode, an optically compensated bend (OCB) mode, an in-plane-switching (IPS) mode or a twisted nematic (TN) mode but the cell mode is not limited thereto.

In a TN mode liquid crystal cell, rod-like liquid crystal molecules are aligned substantially horizontally in a case in which no voltage is applied and are further aligned in a twisted manner in a range of 60° to 120°. The TN mode liquid crystal cell is most often used in a color TFT liquid crystal display device and is mentioned in many literatures.

In a VA mode liquid crystal cell, rod-like liquid crystal molecules are aligned substantially vertically in a ease in which no voltage is applied. Examples of the VA mode liquid crystal cells include (1) a narrowly defined VA mode liquid crystal cell (described in JP 1990-176625A (JP-H02-176625A)) in which rod-like liquid crystal molecules are aligned substantially vertically in a case in which no voltage is applied and are aligned substantially horizontally in a case in which a voltage is applied, (2) a multi-domain VA mode (MVA mode) liquid crystal cell for enlarging the viewing angle (SID97, Digest of Tech. Papers (Proceedings) 28 (1997) 845), (3) a liquid crystal cell in a mode (n-ASM mode) in which rod-like liquid crystal molecules are aligned substantially vertically in a case in which no voltage is applied and are aligned in twisted multi-domain alignment in a case in which a voltage is applied (Proceedings of Japanese Liquid Crystal Conference, 58 and 59 (1998)), and (4) a SURVIVAL mode liquid crystal cell (presented in LCD International 98). The liquid crystal cell may be of any of a patterned vertical alignment (PVA) type, an optical alignment type, and a polymer-sustained alignment (PSA) type. These modes are described in detail in W2006-215326A and JP2008-538819A.

In an IPS mode liquid crystal cell, rod-like liquid crystal molecules are aligned substantially parallel with respect to a substrate and application of an electric field parallel to the substrate surface causes the liquid crystal molecules to respond planarly. The IPS mode displays black in a case in which no electric field is applied and a pair of upper and lower polarizing plates have absorption axes which are orthogonal to each other. A method of improving the viewing angle by reducing light leakage during black display in an oblique direction using an optical compensation sheet is described in JP1998-54982A (JP-H10-54982A), JP 1999-202323A (IP-H11-2023234 JP1997-292522A (JP-H09-292522A), JP1999-133408A (JP-H11-133408A), JP1999-305217A (JP-H11-305217A), JP1998-307291A (JP-H10-307291A), and the like.

[Organic EL Display Device]

As the organic EL display device which is an example of the image display device of the present invention, for example, an embodiment which includes, from the visible side, the polarizing plate of the present invention, a plate having a λ/4 function (hereinafter referred to also as “λ/4 plate”) and an organic EL display panel in this order is suitable.

The “plate having a λ/4 function” as used herein refers to a plate having a function of converting linearly polarized light at a specific wavelength into circularly polarized light (or circularly polarized light into linearly polarized light). Specific examples of an embodiment in which the λ/4 plate is of a single layer structure include a stretched polymer film, and a phase difference film in which an optically anisotropic layer having a function is provided on a support. A specific example of an embodiment in which the λ/4 plate is of a multilayer structure includes a broadband λ/4 plate in which the λ/4 plate and a λ/2 plate are laminated on each other.

The organic EL display panels a display panel configured using an organic EL device in which an organic light emitting layer (organic electroluminescent layer) is sandwiched between electrodes (between a cathode and an anode). The configuration of the organic EL display panel is not particularly limited but any known configuration is adopted.

### EXAMPLES

The present invention will be described below in further detail based on examples. The materials, amounts used, ratios, treatment contents and treatment procedures shown in the examples below can be modified as appropriate in the range of not departing from the spirit of the present invention. Therefore, the scope of the present invention should not be construed as being limited to the following examples.

### Example 1

<Formation of Optical Alignment Film P-1>

A coating solution I for photo alignment prepared with reference to the description of Example 3 of JP2012-155308A was applied to one surface of a polarizer 1 having a film thickness of 20 μm prepared by causing iodine to adsorb to a stretched polyvinyl alcohol film according to Example 1 of JP2001-141926A using a secondary bar.

After application, the solvent was removed by drying to form a photoisomerizable composition layer 1.

The obtained photoisomerizable composition layer 1 was irradiated with polarized ultraviolet rays (at 180 mJ/cm² using an ultra-high pressure mercury lamp) to form an optical alignment film P-1.

<Formation of Optically Anisotropic Layer 1>

The coating solution 1 for an optically anisotropic layer having the following composition was applied to the optical alignment film P-1 by a spin coating method to form a liquid crystal composition layer 1.

The formed liquid crystal composition layer 1 was once heated on a hot plate to 90° C. and then cooled to 60° C. so that the alignment was stabilized in a smectic A phase (SmA phase).

Then, while keeping the temperature at 60° C., the alignment was fixed by the ultraviolet irradiation (at 500 mJ/cm² using an ultra-high pressure mercury lamp) in a nitrogen atmosphere (at an oxygen concentration of 100 ppm) to form an optically anisotropic layer 1 having a thickness of 2.0 μm was formed. Thus, an optical film was prepared.

Coating Solution 1 for Optically Anisotropic Layer

| | | |
|---|---|---|
| Liquid crystal compound L-1 shown below | 43.75 | parts by mass |
| Liquid crystal compound L-2 shown below | 43.75 | parts by mass |
| Mesogen compound A-1 shown below | 12.50 | parts by mass |
| Polymerization initiator S-1 (oxime type) shown below | 3.00 | parts by mass |
| Leveling agent (Compound T-1 shown below) | 0.20 | parts by mass |
| Methyl ethyl ketone | 219.30 | parts by mass |

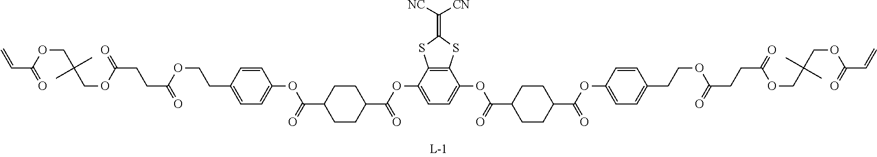 [SMILES: C=CC(=O)OCC(C)(C)COC(=O)CCC(=O)OCCc1ccc(OC(=O)C2CCC(C(=O)Oc3ccc(OC(=O)C4CCC(C(=O)Oc5ccc(CCOC(=O)CCC(=O)OCC(C)(C)COC(=O)C=C)cc5)CC4)c4c3SC(=C(C#N)C#N)S4)CC2)cc1]

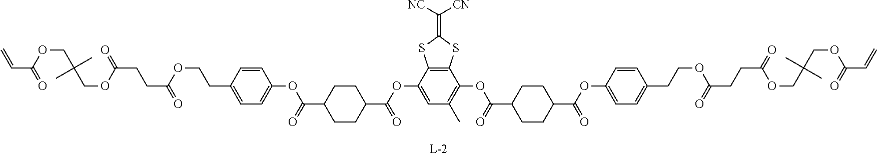 [SMILES: C=CC(=O)OCC(C)(C)COC(=O)CCC(=O)OCCc1ccc(OC(=O)C2CCC(C(=O)Oc3cc(C)c(OC(=O)C4CCC(C(=O)Oc5ccc(CCOC(=O)CCC(=O)OCC(C)(C)COC(=O)C=C)cc5)CC4)c4c3SC(=C(C#N)C#N)S4)CC2)cc1]

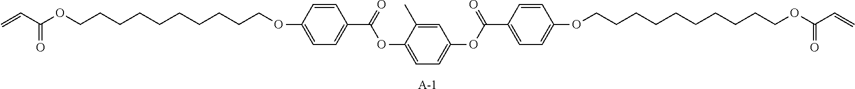

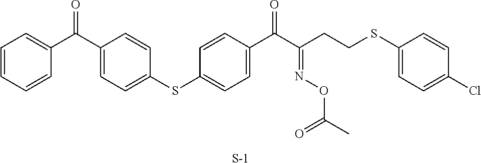 [SMILES: CC(=O)O/N=C(\CCSc1ccc(Cl)cc1)C(=O)c1ccc(Sc2ccc(C(=O)c3ccccc3)cc2)cc1 ; "S-1"]

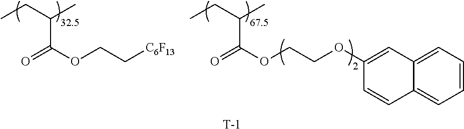

### Examples 2 to 14 and Comparative Examples 1 to 6

Each optically anisotropic layer was formed and then each optical film was prepared in the same manner as in Example 1 except that in the coating solution for an optically anisotropic layer, the kind of the liquid crystal compound and the added amount thereof, and the kind of the mesogen compound and the added amount thereof were changed as shown in Table 1.

<Durability>

The optical film prepared in each of Examples and Comparative Examples was attached to a glass plate with a pressure sensitive adhesive such that the optically anisotropic layer side became the glass side.

The durability of the retardation value was evaluated based on the following standards using Axo Scan (0PMF-1, manufactured by Axometrics Inc.). The results are shown in Table 1 below.

Regarding the test conditions, as shown in Table 1 below, a test in which optical film was left to stand in an environment at 85° C. and a relative humidity of 85% for 240 hours were conducted.

AA: A change amount of the value after test with respect to the initial phase difference value is less than 10%.

A: A change amount of the value after test with respect to the initial phase difference value is 10% or more and less than 20%.

B: A change amount of the value after test with respect to the initial phase difference value is 20% or more and less than 45%.

C: A change amount of the value after test with respect to the initial phase difference value is 45% or more and less than 50%.

D: A change amount of the value after test with respect to the initial phase difference value is 50% or more.

TABLE 1

| | | | | | | | | | | | | | Durability |
|---|---|---|---|---|---|---|---|---|---|---|---|---|---|
| | | | | | | | Mesogen compound | | | | | | 85° C. |
| | | | | | | | | | | Number of | | Number of | Relative |
| | Liquid crystal compound | | | Liquid crystal compound | | | | | | polymer- | Number of | cyclo- | humidity |
| | | Added | I/O | | Added | I/O | | Added | I/O | izable | benzene | hexane | 85% |
| | Kind | amount* | value | Kind | amount* | value | Kind | amount* | value | groups | rings | rings | 240 hours |
| Example 1 | L-1 | 43.75 | 0.626 | L-2 | 43.75 | 0.617 | A-1 | 12.50 | 0.350 | 2 | 3 | 0 | AA |
| Example 2 | L-1 | 43.75 | 0.626 | L-2 | 43.75 | 0.617 | A-2 | 12.50 | 0.371 | 2 | 3 | 0 | AA |
| Example 3 | L-1 | 43.75 | 0.626 | L-2 | 43.75 | 0.617 | A-3 | 12.50 | 0.411 | 2 | 3 | 0 | AA |
| Example 4 | L-1 | 43.75 | 0.626 | L-2 | 43.75 | 0.617 | A-4 | 12.50 | 0.457 | 2 | 3 | 0 | AA |
| Example 5 | L-1 | 43.75 | 0.626 | L-2 | 43.75 | 0.617 | A-5 | 12.50 | 0.470 | 2 | 3 | 0 | AA |
| Example 6 | L-1 | 43.75 | 0.626 | L-2 | 43.75 | 0.617 | A-6 | 12.50 | 0.488 | 3 | 3 | 0 | AA |
| Example 7 | L-1 | 43.75 | 0.626 | L-2 | 43.75 | 0.617 | A-7 | 12.50 | 0.498 | 2 | 3 | 0 | A |
| Example 8 | L-1 | 43.75 | 0.626 | L-2 | 43.75 | 0.617 | A-8 | 12.50 | 0.514 | 2 | 3 | 0 | A |
| Example 9 | L-1 | 43.75 | 0.626 | L-2 | 43.75 | 0.617 | A-9 | 12.50 | 0.525 | 2 | 8 | 0 | B |
| Example 10 | L-1 | 43.75 | 0.626 | L-2 | 43.75 | 0.617 | A-10 | 12.50 | 0.548 | 2 | 3 | 2 | B |
| Example 11 | L-1 | 48.50 | 0.626 | L-2 | 48.50 | 0.617 | A-10 | 3.00 | 0.548 | 2 | 3 | 2 | C |
| Example 12 | L-1 | 48.00 | 0.626 | L-2 | 48.00 | 0.617 | A-10 | 4.00 | 0.548 | 2 | 3 | 2 | B |
| Example 13 | L-1 | 42.25 | 0.626 | L-2 | 42.25 | 0.617 | A-10 | 15.50 | 0.548 | 2 | 3 | 2 | A |
| Example 14 | L-6 | 87.50 | 0.704 | — | — | — | A-10 | 12.50 | 0.548 | 2 | 3 | 2 | C |
| Comparative | L-1 | 43.75 | 0.626 | L-2 | 43.75 | 0.617 | CA-1 | 12.50 | 0.370 | 1 | 1 | 2 | D |
| Example 1 | | | | | | | | | | | | | |
| Comparative | L-1 | 43.75 | 0.626 | L-2 | 43.75 | 0.617 | CA-2 | 12.50 | 0.581 | 2 | 1 | 2 | D |
| Example 2 | | | | | | | | | | | | | |
| Comparative | L-1 | 43.75 | 0.626 | L-2 | 43.75 | 0.617 | CA-3 | 12.50 | 0.595 | 2 | 2 | 1 | D |
| Example 3 | | | | | | | | | | | | | |
| Comparative | L-1 | 43.75 | 0.626 | L-2 | 43.75 | 0.617 | CA-4 | 12.50 | 0.671 | 2 | 2 | 1 | D |
| Example 4 | | | | | | | | | | | | | |
| Comparative | L-1 | 43.75 | 0.626 | L-2 | 43.75 | 0.617 | CA-5 | 12.50 | 0.713 | 2 | 2 | 1 | D |
| Example 5 | | | | | | | | | | | | | |
| Comparative | L-1 | 43.75 | 0.626 | L-2 | 43.75 | 0.617 | CA-6 | 12.50 | 0.767 | 2 | 2 | 1 | D |
| Example 6 | | | | | | | | | | | | | |

*The added amount indicates a ratio (% by mass) with respect to the total mass of the liquid crystal compound and the mesogen compound.

In Table 1, the structures of the liquid crystal compound L-6, and the mesogen compounds A-2 to A-10 and CA-1 to CA-6 are shown below.

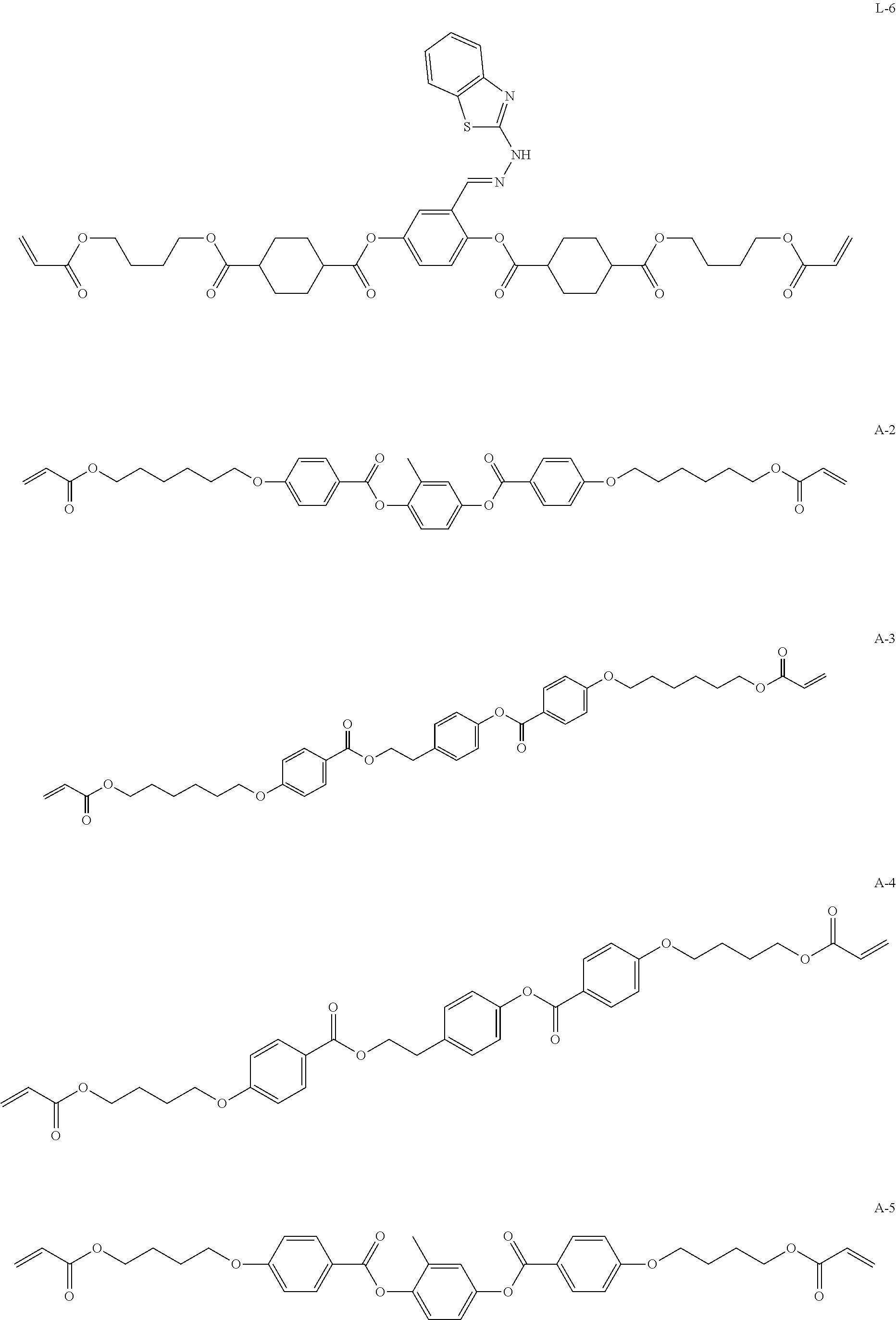

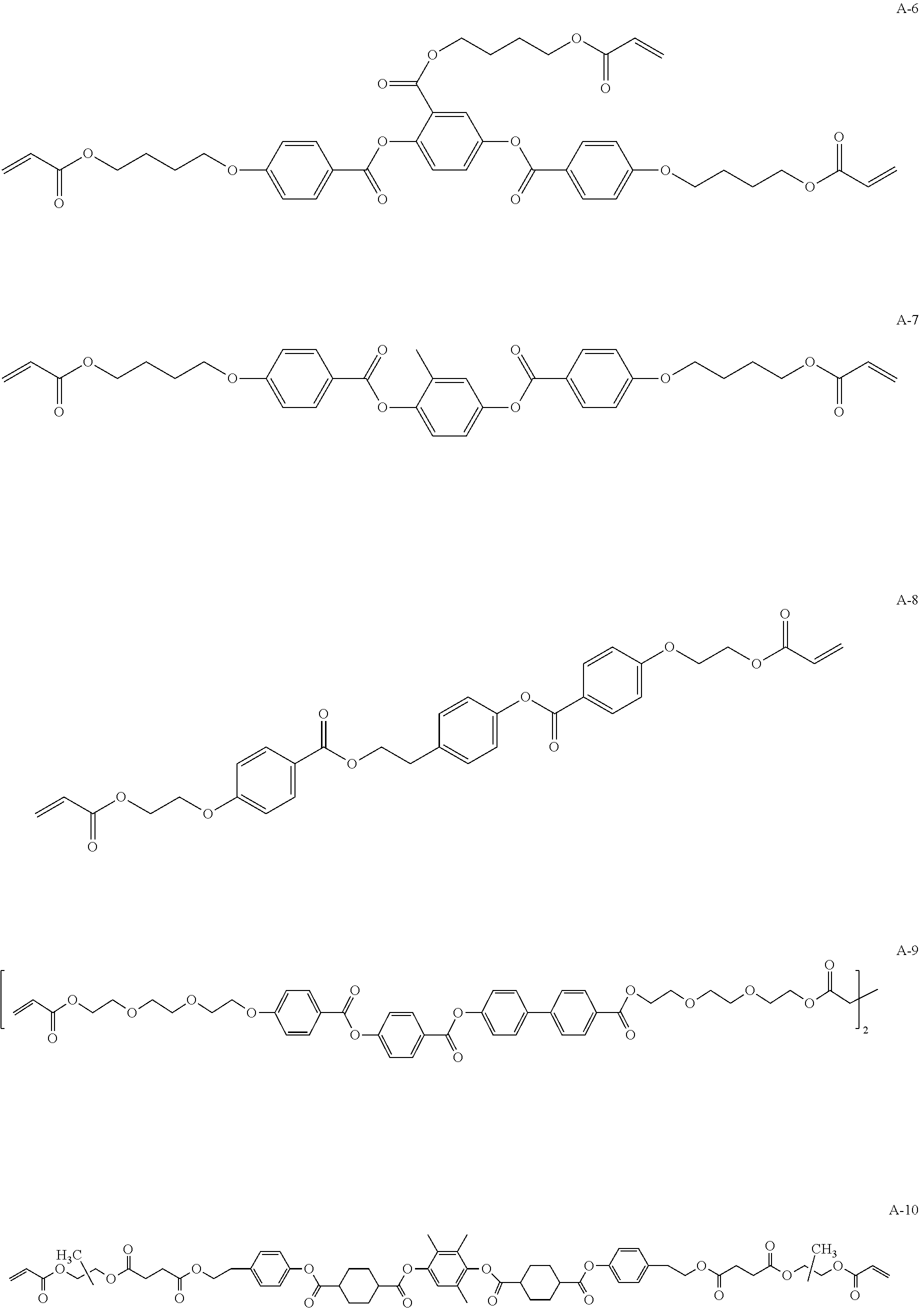

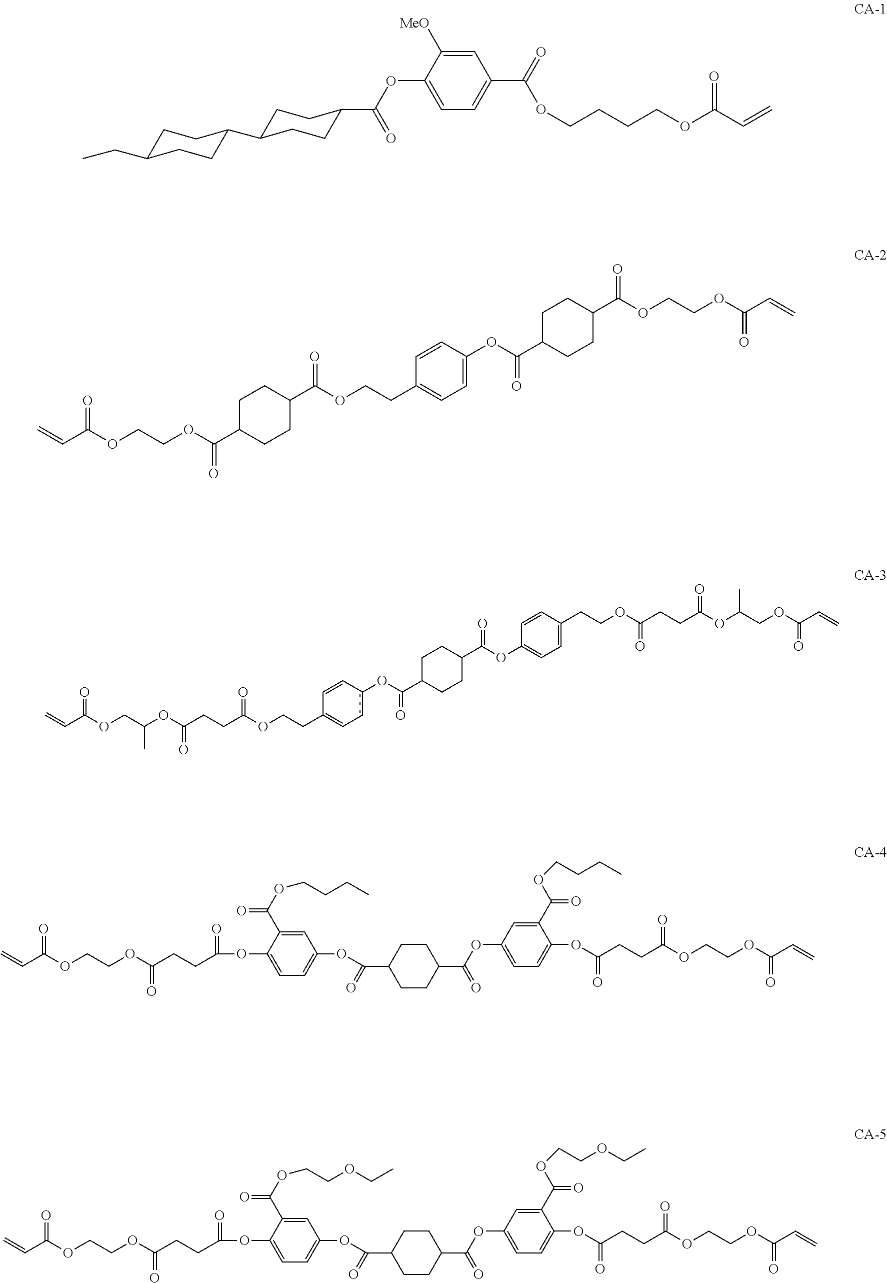

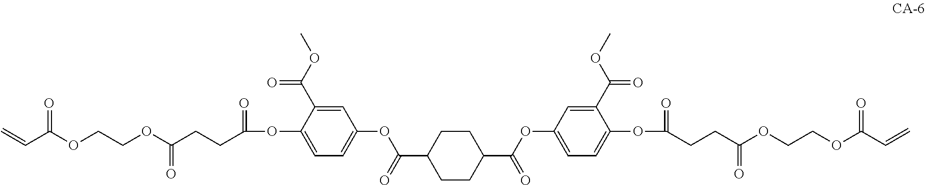 [SMILES: C=CC(=O)OCCOC(=O)CCC(=O)Oc1ccc(OC(=O)C2CCC(C(=O)Oc3ccc(OC(=O)CCC(=O)OCCOC(=O)C=C)c(C(=O)OC)c3)CC2)cc1C(=O)OC]

From the results shown in Table 1, it was found that in a case of using a mesogen compound having one polymerizable group, the durability of the optically anisotropic layer was deteriorated (Comparative Example 1).

In addition, it was found that although a mesogen compound having two polymerizable groups was used, in a ease where the I/O value of the mesogen compound was more than 0.56, the durability of the optically anisotropic layer was deteriorated (Comparative Examples 2 to 6).

In contrast, it was found that in all cases of using a mesogen compound having two polymerizable groups and an I/O value of 0.56 or less, the durability of the optically anisotropic layer was improved (Examples 1 to 14).

Particularly, from comparison of Examples 10 to 13, it was found that in a case where the content of the mesogen compound was 4% by mass or more with respect to the total mass of the liquid crystal compound and the mesogen compound, the durability of the optically anisotropic layer was further improved.

Further, from comparison of Examples 10 and 14, it was found that in a case where the liquid crystal compound is a liquid crystal compound represented by Formula (1) in which in is 1 or 2, the durability of the optically anisotropic layer was further improved.

### EXPLANATION OF REFERENCES

10: optical film

12: optically anisotropic layer

14: alignment film

16: support

18: hard coat layer

What is claimed is:

1. An optical film comprising, at least:
an optically anisotropic layer,
wherein the optically anisotropic layer is a layer obtained by polymerizing a polymerizable liquid crystal composition containing a liquid crystal compound represented by Formula (1), a mesogen compound having two or more polymerizable groups, and a polymerization initiator,
an I/O value of the liquid crystal compound is more than 0.56, and
an I/O value of the mesogen compound is 0.56 or less, 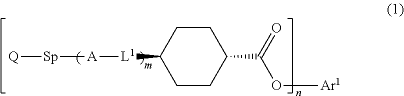
in Formula (1),
Ar¹ represents an n-valent aromatic group,
L¹ represents a single bond, —COO—, or —OCO—,
A represents an aromatic ring having 6 or more carbon atoms or a cycloalkylene ring having 6 or more carbon atoms,
Sp represents a single bond, a linear or branched alkylene group having 1 to 12 carbon atoms, or a divalent linking group in which one or more —CH₂— groups that constitute a linear or branched alkylene group having 1 to 12 carbon atoms are substituted with —O—, —S—, —NH—, —N(Q)-, or —CO—,
Q represents a polymerizable group,
m represents an integer of 0 to 2, and
n represents an integer of 1 or 2,
where all of L¹, A, Sp, and Q, a plurality of which are provided depending on the number of in or n, may be the same or different from each other.

2. The optical film according to claim 1,
wherein the liquid crystal compound is a liquid crystal compound exhibiting reverse wavelength dispersion.

3. The optical film according to claim 1,
wherein a content of the mesogen compound is 4% by mass or more with respect to a total mass of the liquid crystal compound and the mesogen compound.

4. The optical film according to claim 2,
wherein a content of the mesogen compound is 4% by mass or more with respect to a total mass of the liquid crystal compound and the mesogen compound.

5. The optical film according to claim
wherein the liquid crystal compound is a liquid crystal compound represented by Formula (1) in which m is 1 or 2.

6. The optical film according to claim 2,
wherein the liquid crystal compound is a liquid crystal compound represented by Formula (1) in which m is 1 or 2.

7. The optical film according to claim 3,
wherein the liquid crystal compound is a liquid crystal compound represented by Formula (1) in which m is 1 or 2.

8. The optical film according to claim 1,
wherein the polymerization initiator is an oxime type polymerization initiator.

9. The optical film according to claim 2,
wherein the polymerization initiator is an oxime type polymerization initiator.

10. The optical film according to claim 3,
wherein the polymerization initiator is an oxime type polymerization initiator.

11. The optical film according to claim 5,
wherein the polymerization initiator is an oxime type polymerization initiator.

12. The optical film according to claim 1,
wherein the mesogen compound has at least one ring structure selected from the group consisting of a benzene ring and a cyclohexane ring.

13. The optical film according to claim 2,
wherein the mesogen compound has at least one ring structure selected from the group consisting of a benzene ring and a cyclohexane ring.

14. The optical film according to claim 3,
wherein the mesogen compound has at least one ring structure selected from the group consisting of a benzene ring and a cyclohexane ring.

15. The optical film according to claim 5,
wherein the mesogen compound has at least one ring structure selected from the group consisting of a benzene ring and a cyclohexane ring.

16. The optical film according to claim 8,
wherein the mesogen compound has at least one ring structure selected from the group consisting of a benzene ring and a cyclohexane ring.

17. The optical film according to claim 1,
wherein the number of cyclohexane rings in the mesogen compound is 2 or less.

18. A polarizing plate comprising:
the optical film according to claim 1; and
a polarizer.

19. An image display device comprising the optical film according to claim 1.

20. An image display device comprising the polarizing plate according to claim 18.
